(19) United States
(12) Patent Application Publication
(10) Pub. No.: US 2026/0019541 A1
(43) Pub. Date: Jan. 15, 2026

(54) IMAGE PROJECTION APPARATUS, METHOD, AND STORAGE MEDIUM

(71) Applicant: SAMSUNG ELECTRONICS CO., LTD., Suwon-si (KR)

(72) Inventors: Hyunku KANG, Suwon-si (KR); Hyungjun LIM, Suwon-si (KR)

(73) Assignee: SAMSUNG ELECTRONICS CO., LTD., Suwon-si (KR)

(21) Appl. No.: 19/276,853

(22) Filed: Jul. 22, 2025

Related U.S. Application Data
(63) Continuation of application No. PCT/KR2025/009905, filed on Jul. 8, 2025.

(30) Foreign Application Priority Data
Jul. 9, 2024 (KR) 10-2024-0090663
Dec. 4, 2024 (KR) 10-2024-0178630

(51) Int. Cl. H04N 9/31

(52) U.S. Cl. CPC H04N 9/3179; H04N 9/3194

(57) ABSTRACT

A method for operating an image projector, includes: determining a brightness variation coefficient regarding an input pixel to a gradation conversion model and an output pixel corresponding to the input pixel; obtaining a projection plane deviation correction coefficient reflecting a characteristic of a projection plane obtained from an at least one distance sensor; and generating an output image to be projected by the image projector onto a projection region of the projection plane by correcting a brightness of a pixel of an input image, based on at least one of the brightness variation coefficient or the projection plane deviation correction coefficient.

### CROSS-REFERENCE TO RELATED APPLICATIONS

This application is a by-pass continuation application of International Application No. PCT/KR2025/009905, filed on Jul. 8, 2025, which is based on and claims priority to Korean Patent Application No. 10-2024-0090663, filed on Jul. 9, 2024, and Korean Patent Application No. 10-2024-0178630, filed on Dec. 4, 2024, in the Korean Intellectual Property Office, the disclosures of which are incorporated by reference herein their entireties.

### BACKGROUND

### 1. Field

The disclosure relates to an image projection apparatus, a method, and storage medium for displaying an image on a projection surface.

### 2. Description of Related Art

Projection devices may be analog-type projection devices (“analog projection devices”) or digital-type projection devices (“digital projection devices”). An analog projection device may provide visual information using a medium, such as a film. The digital projection device may provide visual information using digital signals. The digital projection device may include a beam projector (hereinafter referred to as “projector”). The projector may be classified as a display device. The projector may be implemented as a cathode ray tube (CRT) projector, a liquid crystal display (LCD) projector, or a digital light processing (DLP) projector depending on how light is generated.

The projector is used mainly to display multimedia content that is directly input to the projector. When the projector is connected to an electronic device, e.g., a digital television, through a wired or wireless communication network, the projector can display the multimedia content received from the electronic device.

The projector may project photos, pictures, text, images, or video on a screen through a lens. The projector may also called as an image projection apparatus that may convert data about an image or a video (in the form of a file) into an optical signal (or optical image) and output the optical signal. The output of the optical signal may correspond to an irradiation. The output image displayed on the screen by the image projection apparatus may have an uneven brightness due to characteristics of the projection plane or characteristics of the lens for radiating the optical signal.

The above-described information may be provided as related art for the purpose of helping understanding of the disclosure. The foregoing cannot be claimed as, or used to determine, the prior art related to the disclosure.

### SUMMARY

According to an aspect of the disclosure, an image projection apparatus includes: at least one distance sensor; an image projector; at least one memory comprising a non-volatile storage medium storing instructions; and at least one processor operatively connected with the at least one distance sensor, the image projector, and the at least one memory and comprising a processing circuit, wherein the instructions, when executed by the at least one processor individually or collectively, cause the image projection apparatus to: determine a brightness variation coefficient regarding an input pixel to a gradation conversion model and an output pixel corresponding to the input pixel; obtain a projection plane deviation correction coefficient reflecting a characteristic of a projection plane obtained from the at least one distance sensor; and generate an output image to be projected by the image projector onto a projection region of the projection plane by correcting a brightness of a pixel of an input image based on at least one of the brightness variation coefficient or the projection plane deviation correction coefficient.

According to an aspect of the disclosure, a method for operating an image projector, includes: determining a brightness variation coefficient regarding an input pixel to a gradation conversion model and an output pixel corresponding to the input pixel; obtaining a projection plane deviation correction coefficient reflecting a characteristic of a projection plane obtained from an at least one distance sensor; and generating an output image to be projected by the image projector onto a projection region of the projection plane by correcting a brightness of a pixel of an input image, based on at least one of the brightness variation coefficient or the projection plane deviation correction coefficient.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an operation of projecting an image onto a projection plane in an image projection system according to an embodiment;

FIG. 2 is a view illustrating an example in which an image is projected onto a projection plane in an image projection system according to an embodiment;

FIG. 3 is a view illustrating correction of a brightness deviation in an image projection apparatus according to an embodiment;

FIG. 4 is a block view illustrating a configuration for projecting image data in an image projection apparatus according to an embodiment;

FIG. 5 is a flowchart illustrating control for obtaining position data of an area where image data is to be projected in an image projection apparatus according to an embodiment;

FIG. 6A is a view illustrating brightness deviation correction for increasing the brightness of input pixels using a gradation conversion model;

FIG. 6B is a view illustrating brightness deviation correction for decreasing the brightness of input pixels using a gradation conversion model;

FIG. 6C is a view illustrating brightness correction using a gradation conversion model;

FIGS. 7A and 7B are views illustrating obtaining an optical deviation correction coefficient considering a vignetting characteristic of a lens;

FIG. 8A is a view illustrating that a brightness deviation occurs in a non-planar projection plane according to an incident angle of a projection beam;

FIG. 8B is a view illustrating compensating for a brightness deviation using a second projection plane deviation correction coefficient Gθ obtained considering an incident angle θ for each sensing measurement point;

FIG. 8C is a view illustrating compensating for brightness deviation using a first projection plane deviation correction coefficient Gd obtained considering an arrival distance d for each sensing measurement point;

FIG. 9 is a view illustrating an operation of generating an output image by performing brightness compensation and/or brightness deviation compensation by applying a weight to the input image; and

FIG. 10 is a view illustrating an electronic device in a network environment according to one or more embodiments.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

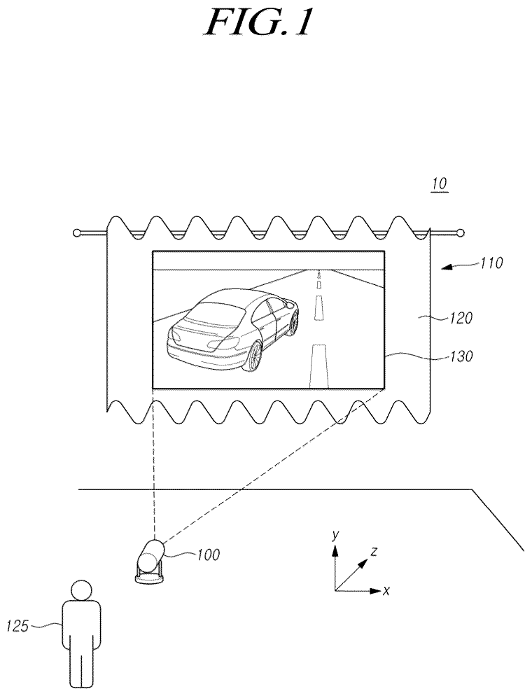

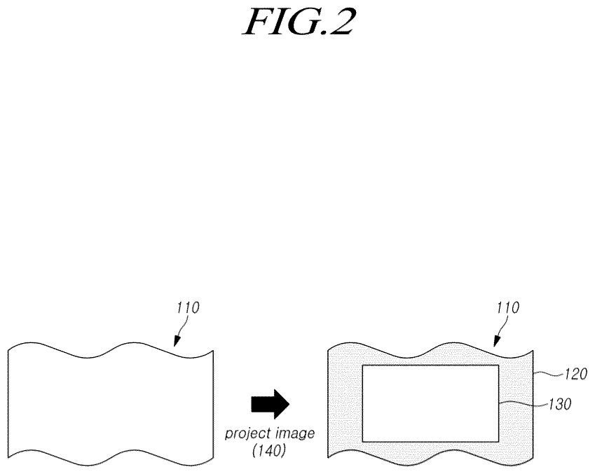

FIG. 1 is a view illustrating an operation of projecting an image on a projection plane 110 in an image projection system 10 according to an embodiment, and FIG. 2 is a view illustrating an example of projecting an image on the projection plane 110 in an image projection system 10 according to an embodiment.

In FIGS. 1 and 2, it is assumed that the projection plane 110 is non-planar, but this is merely an example, but various embodiments proposed in the disclosure may be equally applied to planar or multi-plane projection planes 110.

Referring to FIG. 1 or FIG. 2, the image projection system 10 may include an image projection apparatus 100 (e.g., a beam projector) or a projection plane 110. The projection plane 110 may correspond to, e.g., a white or silver film for projecting an optical signal on a screen. The projection plane 110 may be, e.g., a planar surface or a multi-plane such as a wall capable of projecting an optical signal, or a non-planar surface such as a curtain.

For example, the projection plane 110 may be a non-planar, curved surface having a predetermined flexural characteristic. The projection plane 110 may be referred to as a ‘curved projection plane’. The curved projection plane is a projection plane that may be made, e.g., by a curtain, tent, or banner. Here, the ‘projection plane’ may be used to refer to any one of a planar projection plane, a multi-plane projection plane, or a non-planar projection plane. In the disclosure, a non-planar projection plane is exemplarily assumed in the drawings or detailed description, so the ‘projection plane’ is regarded as the ‘non-planar projection plane’, but various embodiments of the present disclosure are not limited thereto.

The curvature characteristic on the non-planar projection plane 110 may be a characteristic related to the shape in which the projection plane 110 is bent or curved. The curvature characteristic may include, e.g., a characteristic of a wave formed by a crest and a root in a predetermined direction, such as horizontal (or left and right), vertical (or up and down), or diagonal direction. In this case, the curvature characteristic may have an inclined surface due to the formation of a crest and a root. The inclined surface may have a predetermined inclination.

The projection plane 110 may include a projection region 120. The projection region 120 may be, e.g., an area through where projection beams corresponding to an optical signal transmitted by the image projection apparatus 100 may reach the projection plane 110. The projection region 120 may have a curvature characteristic substantially identical or similar to that of the projection plane 110. The projection region 120 may include pixel projection points where the projection beams will reach. An image corresponding to a specific pixel may be displayed at the pixel projection point by the corresponding projection beam. The pixel is an element that is the smallest unit to constitute an image to be displayed on the projection region 120, and may have a predetermined unit area. The pixel may have a color value including R (red), G (green), and B (blue), which are subpixels corresponding to the three elements of light that substantially represent color, and/or a luminance value indicating brightness.

The projection region 120 may include a non-screen display region and a screen display region 130. The non-screen display region may be an area in which pixel projection points reached by the projection beam are distributed, but a substantial image is not displayed. For example, the pixel displayed by the projection beam projected onto the non-screen display region may not have a color value. The screen display region 130 may be an area in which a substantial image is displayed by a projection beam reaching the pixel projection point. For example, a pixel displayed by a projection beam projected onto the screen display region 130 may have a specific color value and a specific luminance value. In other words, the screen display region 130 may be an area in which an image is substantially displayed by projection beams transmitted to the projection region 120 by the image projection apparatus 100. The projection region 120 or the screen display region 130 may have a curvature characteristic substantially identical or similar to that of the projection plane 110.

The image projection apparatus 100 may generate output image data (hereinafter referred to as an ‘output image’) through correction of the input image data (hereinafter referred to as an ‘input image’). According to an example, the image projection apparatus 100 may generate an output image in which the brightness deviation is corrected by performing brightness deviation correction on the input image. For example, the image projection apparatus 100 may perform brightness correction on the input image to enhance the contrast ratio of the output screen. For example, the image projection apparatus 100 may perform brightness correction to increase the brightness of pixels with high luminance among pixels of the input image and decrease the brightness of pixels with low luminance so that the outline of the image may be clarified in the output image. For example, the image projection apparatus 100 may perform brightness deviation correction on the input image considering the characteristic of the projection lens that may cause optical deviation and/or the characteristic of the projection plane 110 regarding the shape and/or curvature of the projection plane 110. This is described below in detail. The image projection apparatus 100 may perform distortion correction to compensate for image distortion in addition to brightness deviation correction. The image projection apparatus 100 may generate an output image by performing plane distortion correction such as keystone correction on the input image, e.g., if the projection plane 110 is flat like a screen. When the projection plane 110 is a multi-plane surface, the image projection apparatus 100 may generate an output image by performing multi-plane distortion correction on the input image. The image projection apparatus 100 may generate an output image by performing non-planar distortion correction on the input image when the projection plane 110 is non-planar, such as a curved surface. In other words, the image projection apparatus 100 may perform automatic correction (auto keystone) on the input image so that the image displayed on the screen display region 130 may look like a planar image without distortion considering the curvature characteristic of the projection plane 110. The application of automatic correction for displaying an image that is not distorted, such as a planar image, on the projection plane 110 having a curvature characteristic corresponding to a non-plane in the image projection apparatus 100 may not be directly related to one or more embodiments of the disclosure, so a detailed description thereof is omitted.

According to an example, the image projection apparatus 100 may convert the brightness deviation-corrected output image into an optical signal to transmit a plurality of projection beams toward the projection plane 110. The input image may be, e.g., image data input according to a content service such as a movie or a game. The optical signal transmitted by the image projection apparatus 100 may be projected onto the projection region 120 of the projection plane 110.

According to an example, the image projection apparatus 100 may correct the output image by reflecting the viewpoint of the viewer 125. For example, the image projection apparatus 100 may provide a screen with an optimized contrast ratio to the viewer 125 by performing brightness deviation correction on the input image considering the viewer 125's viewpoint to generate an output image.

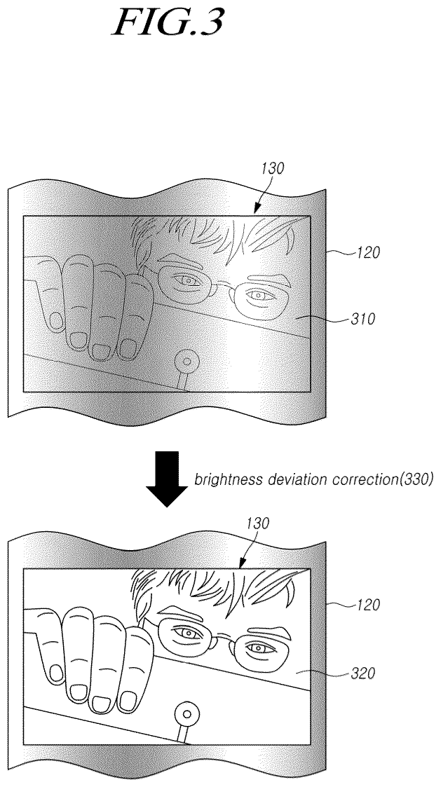

FIG. 3 is a view illustrating correction of a brightness deviation in an image projection apparatus (e.g., the image projection apparatus 100 of FIG. 1) according to an embodiment.

Although FIG. 3 assumes that the projection plane (e.g., the projection plane 110 of FIG. 1 or FIG. 2) is non-planar, brightness deviations may also occur on the output screen displayed on the planar or multi-plane projection plane, and the brightness deviation correction method of the disclosure may be applied thereto. Further, the brightness deviation correction method proposed in the disclosure is described by assuming an output screen to be displayed on the projection plane 110 by the image projection apparatus 100, but this is an example and may be partially applied to electronic devices e.g., notebook PCs, desktop PCs, tablet devices, smartphones, televisions, and set-top boxes that have their own displays or may be connected to monitors based on specific wired/wireless communication standards. However, since an electronic device that displays an output screen through a display such as a monitor is not based on a projection method, only a method of defining a gradation conversion model in advance and correcting the brightness of an input pixel based thereupon may be applied.

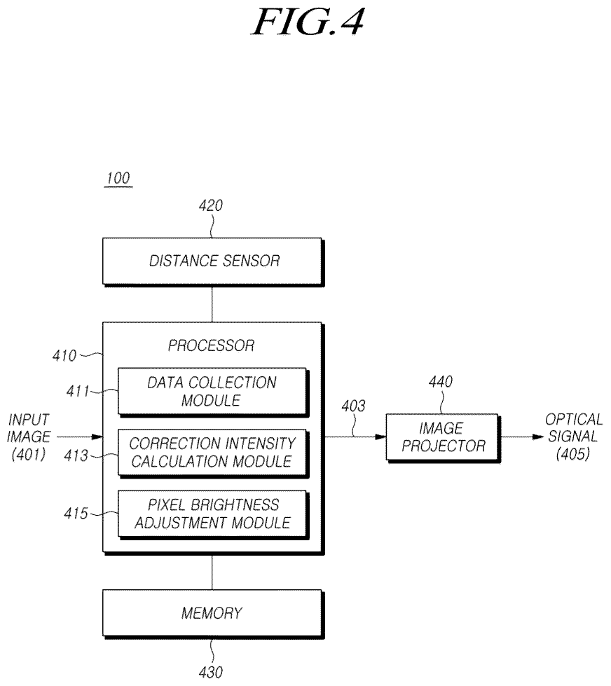

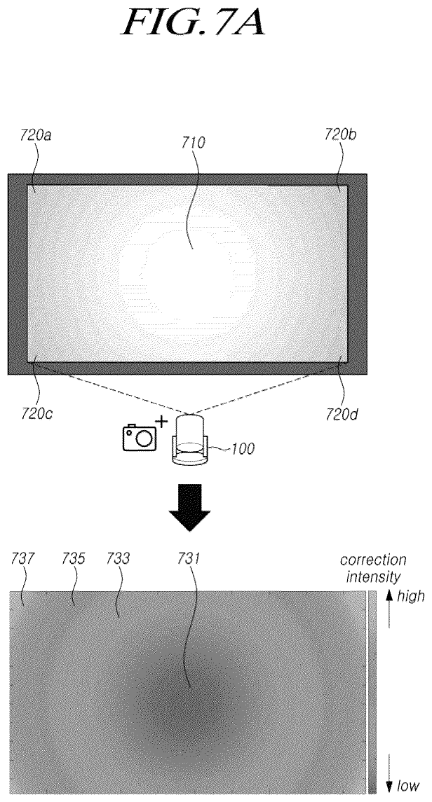

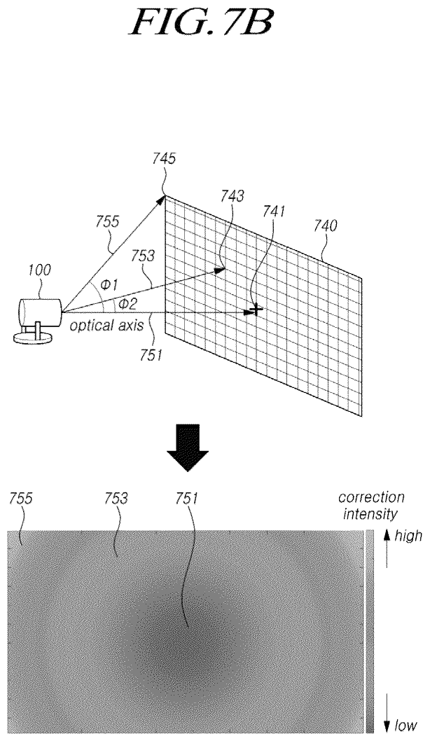

Referring to FIG. 3, the first screen 310 is an output screen displayed in the screen display region (e.g., the screen display region 130 of FIG. 1 or FIG. 2) by projecting an output image (e.g., the output image 403 of FIG. 4), which is generated without brightness correction 330 (hereinafter referred to as ‘brightness deviation correction 330′) for the input image (e.g., the input image 401 of FIG. 4), onto the projection region (e.g., the projection region 120 of FIG. 1 or FIG. 2). The brightness deviation may mean a degree of non-uniform brightness for each area of the output screen due to loss from optical deviation and/or projection plane deviation. The brightness correction refers to adjusting the brightness of some or all of the pixels of the input image in order to obtain a desired contrast ratio on the output screen. Brightness deviation correction, which is one of the brightness corrections, refers to adjusting the brightness for each pixel or partial area (hereinafter referred to as a ‘partial display region’) (e.g., the first and second partial display regions 731, 733, 735, and 737 of FIG. 7A) to compensate in advance for any potential brightness loss on the output screen, ensuring that the output screen has a uniform brightness overall.

In the first screen 310, due to the absence of brightness deviation correction 330 for the input image 401, the overall brightness may not be consistent, and non-uniform brightness deviation may occur. This brightness deviation may occur because the intrinsic characteristics (e.g., projection lens characteristics) of the projection beams transmitted by the image projection apparatus 100 are not the same, and/or the characteristics (e.g., projection plane characteristics) of the projection plane 110 on which the projection beams transmitted by the image projection apparatus 100 are to be projected are not the same. The projection lens characteristic may be a unique optical characteristic of the image projection apparatus 100, such as a lens vignetting phenomenon. Items representing the characteristics of the projection plane may include, for example, the distance that the projection beams transmitted by the image projection apparatus 100 travel to reach the projection plane 110 (hereinafter referred to as “arrival distance d”). The arrival distance of the projection beams may be defined as a distance from the image projection apparatus 100 to a point where the corresponding projection beam is to be projected on the projection plane 110. An item representing the projection plane characteristics may be, e.g., an incident angle on the projection plane 110 due to the projection direction of the projection beams transmitted by the image projection apparatus 100.

According to an example, the arrival distance of the projection beams may be positive at the position of the point where the corresponding projection beam is to be projected on the projection plane 110 (or the screen display region 130). For example, the arrival distance of the projection beam where the projection point is near the center of the screen display region 130 may be relatively shorter than the arrival distance of the projection beam where the projection point is near the edge of the screen display region 130. A projection beam having a short arrival distance may have relatively less loss of brightness than a projection beam having a long arrival distance. As a result, a predetermined brightness deviation may occur in a pixel displayed near the center of the screen display region 130 and a pixel displayed near the edge of the screen display region 130.

According to an example, when the projection plane 110 is a non-plane having a predetermined curvature characteristic, the arrival distance of the projection beams may be affected by the predetermined curvature characteristic of the projection plane 110. The curvature characteristic may be a characteristic related to the shape in which the projection plane 110 is bent or curved. The curvature characteristic of the projection plane 110 may include, e.g., the characteristic of a wave formed by crests and roots in a predetermined direction, such as horizontal (or left and right), vertical (or up and down), or diagonal direction. In this case, the curvature characteristic may have an inclined surface due to the formation of a crest and a root. The inclined surface may have a predetermined inclination. In this case, the arrival distance of the projection beam in which the projection point is near the crest of the screen display region 130 may be relatively shorter than the arrival distance of the projection beam in which the projection point is near the root of the screen display region 130. A projection beam having a short arrival distance may have relatively less loss of brightness than a projection beam having a long arrival distance. For this reason, a predetermined brightness deviation may occur in the pixels displayed near the crest of the screen display region 130 and the pixels displayed near the root of the screen display region 130.

For the reasons, a brightness deviation in which brightness is relatively bright or relatively dark for each display region may appear on the first screen 310.

The second screen 320 is an output screen displayed on the screen display region 130 by projecting the output image 403 generated by performing brightness deviation correction 330 on the input image 401 onto the projection region 120. In the second screen 320, by performing brightness deviation correction 330 on the input image 401, brightness may be uniformly represented as a whole. In other words, it may be identified that the brightness deviation does not substantially occur on the second screen 320.

According to an example, the image projection apparatus 100 may correct the brightness of the input pixel (hereinafter referred to as ‘input pixel brightness (Bin(i))’ where i is a pixel index) to determine the brightness of the output pixel (hereinafter referred to as ‘output pixel brightness (Bout(i)’, where i is a pixel index′) to enhance the contrast ratio of the second screen 320. The image projection apparatus 100 may perform a contrast ratio enhancement that brightens a bright portion of the output image and darkens a dark portion of the output image so that the outline of the image may be clearly visible in the output image.

According to an example, the image projection apparatus 100 may determine a weight (e.g., a brightness variation coefficient (δcurve), an optical deviation correction coefficient (GΦ), and a projection plane deviation correction coefficient G) to be applied to input pixels to be projected in a display region (e.g., near the edge or root of the screen display region 130) that was displayed darkly on the first screen 310 to be relatively higher than a weight (e.g., a brightness variation coefficient, an optical deviation correction coefficient, and a projection plane deviation correction coefficient) to be applied to input pixels to be projected in a display region (e.g., near the center or crest of the screen display region 130) that was displayed brightly on the first screen 310. For example, the image projection apparatus 100 may determine a weight (e.g., a brightness variation coefficient, an optical deviation correction coefficient, and a projection plane deviation correction coefficient) to be applied to input pixels to be projected in a display region (e.g., near the center or crest of the screen display region 130) that was displayed brightly on the first screen 310 to be relatively lower than a weight (e.g., a brightness variation coefficient, an optical deviation correction coefficient, and a projection plane deviation correction coefficient) to be applied to input pixels to be projected in a display region (e.g., near the edge or root of the screen display region 130) that was displayed darkly on the first screen 310. The image projection apparatus 100 may perform brightness deviation correction 330 on the input pixels based on the weight determined for each input pixel. In the second screen 320, by performing brightness deviation correction 330 on the input image 401, the brightness may be consistent as a whole.

FIG. 4 illustrates a configuration for projecting image data in an image projection apparatus (e.g., the image projection apparatus 100 of FIG. 1) according to an embodiment.

Referring to FIG. 4, the image projection apparatus 100 may include at least one processor 410 (hereinafter, referred to as the processor 410), at least one sensor, at least one memory 430 (hereinafter, referred to as the memory 430), or an image projector 440. At least one sensor may include a distance sensor 420. The distance sensor 420 may be a time of flight (ToF) sensor, a depth camera, or a ToF camera.

The distance sensor 420 may obtain position data corresponding to a plurality of sensing measurement points included in the projection plane (e.g., the projection plane 110 of FIG. 1) and/or the projection region (e.g., the projection region 120 of FIG. 1). The sensing measurement points may be distributed in the projection plane 110 and/or the projection region 120. The sensing measurement points may be regularly or irregularly distributed over the projection plane 110 and/or the projection region 120. The sensing measurement points may be points where the projection beams transmitted by the distance sensor 420 reach the projection plane 110 and/or the projection region 120. For example, the distance sensor 420 may obtain position data of the corresponding sensing measurement point by receiving the IR signal that is emitted and reflected from the sensing measurement points and returns. The position data may include a space orthogonal coordinate (or a three-dimensional (3D) orthogonal coordinate system) (hereinafter referred to as a ‘space orthogonal coordinate system’) corresponding to the position of each of the sensing measurement points in the coordinate space (3D). For example, the space orthogonal coordinate system corresponding to the position of each of the sensing measurement points may be referred to as a ‘coordinate value P(x, y, z)’. The projection plane 110 may include, e.g., about 250 sensing measurement points. In this case, the position data may include about 250 coordinate values.

According to an example, when the projection plane 110 is non-planar, the sensing measurement points may be irregularly distributed and disposed on the projection plane 110 and/or the projection region 120. For example, assuming the distance sensor 420 that transmits the beams so that the sensing measurement points are evenly distributed on the planar projection plane, the sensing measurement points that the projection beams transmitted by the distance sensor 420 will reach may provide distribution in proportion to the inclination of the non-planar projection plane 110. In other words, the sensing measurement points present in a highly inclined area (hereinafter, a ‘first inclined surface’) in the non-planar projection plane 110 may be distributed and disposed at relatively wide intervals compared to the sensing measurement points present in a relatively less inclined area (hereinafter, a ‘second inclined surface’). Therefore, the density of the sensing measurement points on the first inclined surface may be relatively lower than the density of the sensing measurement points on the second inclined surface. The first inclined surface may be distinguished based on the difference in the degree of relative local gradient from the second inclined surface due to the curvature of the projection plane 110, which may be an exemplary assumption.

The at least one sensor may provide sensing data related to the position of the image projection apparatus 100 and/or the position of the viewer (e.g., the viewer 125 of FIG. 1). The sensing data obtained by the at least one sensor may include information to be used to obtain the position of the viewer 125. The processor 410 may predict the viewpoint where the viewer 125 views the projection plane 110 considering the position of the viewer 125 obtained based on the sensing data. The processor 410 may identify the position of the image projection apparatus 100 based on the sensing data.

The memory 430 may store various data used by at least one component (e.g., the processor 410 or the distance sensor 420) of the image projection apparatus 100. The data may include, e.g., input data or output data for software (e.g., a program) and related commands. The memory 430 may include volatile memory or nonvolatile memory. The program may be stored as, e.g., in the memory 430. According to an example, the memory 430 may include an operating system, middleware, or an application.

The memory 430 may store data for brightness deviation correction. The memory 430 may store data for enhancing the contrast ratio and correcting the brightness deviation of the output image due to an optical deviation, and/or a projection plane deviation in the image projection apparatus 100, for example.

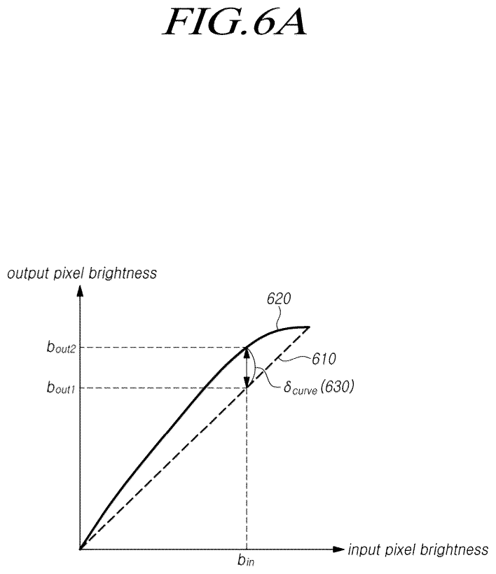

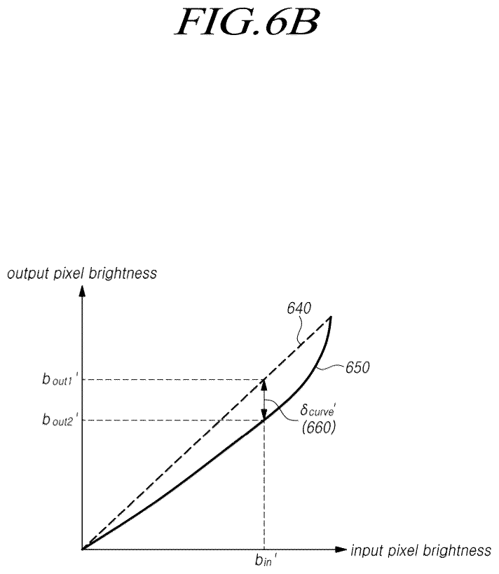

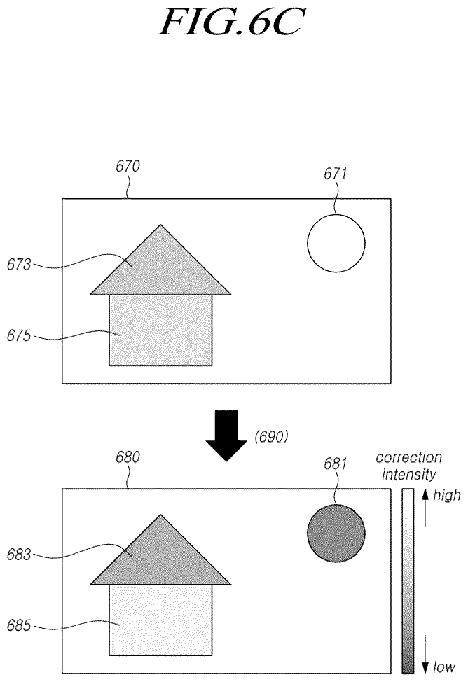

According to an example, the memory 430 may include one or more gradation conversion models for enhancing the contrast ratio of the output image (e.g., see FIG. 6C). One or more gradation conversion models may be pre-stored in the memory 430 in the production process step of the image projection apparatus 100. The gradation conversion model may define a brightness variation coefficient δcurve (e.g., the first brightness variation coefficient (δcurve1) 630 of FIG. 6A or the second brightness variation coefficient (δcurve2) 660 of FIG. 6B) for correcting the brightness in order to enhance the contrast ratio for each brightness of the input pixel (hereinafter referred to as ‘input pixel brightness Bin(i)’, where i is the pixel index) (see FIG. 6A or FIG. 6B). For example, the memory 430 may store the gradation conversion model for enhancing the contrast ratio considering the characteristic of the projection lens. For example, the memory 430 may store gradation conversion models to be selectively applied corresponding to the type of content (e.g., movie mode, game mode, or sports mode). For example, the memory 430 may store gradation conversion models to be selectively applied in response to an image output mode (e.g., natural image, soft image, bright image, dark image). The brightness variation coefficient δcurve of the gradation conversion model stored in the memory 430 may be adjusted in response to the contrast ratio of the output image changed by the user. A new gradation conversion model may be registered in the memory 430 according to the user's request.

According to an example, the memory 430 may store data related to the characteristic of the projection lens that may cause optical deviation in the image projection apparatus 100. The data related to the characteristic of the projection lens may include at least one lookup table (LUT). The LUT may define an optical deviation correction coefficient GΦ for correcting optical deviation due to the characteristic of the projection lens for each pixel of the input image. For example, the memory 430 may include at least one LUT for correcting brightness deviation (e.g., see FIG. 7A or FIG. 7B) for each pixel due to the vignetting characteristic of the lens. For example, the LUT may define an optical deviation correction coefficient GΦ for correcting optical deviation due to the vignetting characteristic for each partial display region of the input image (e.g., the first to second partial display regions 731, 733, 735, and 737 of FIG. 7A). For example, the LUT may define an optical deviation correction coefficient GΦ for correcting the optical deviation for each partial display region 731, 733, 735, and 737 in which optical deviation due to the vignetting characteristic occurs in the output image. The optical deviation correction coefficient GΦ of the LUT stored in the memory 430 may be changed or adjusted according to the user's request.

According to an example, a new LUT may be registered in the memory 430 according to the user's request. For example, the image projection apparatus 100 may examine whether there has been a change in the characteristic of the projection lens periodically (e.g., the characteristic check period of the projection lens) and/or aperiodically (e.g., the user's request to check the characteristic of the projection lens). For example, the image projection apparatus 100 (or the processor 410) may transmit a test image (e.g., a single gradation image) to the projection plane 110 and obtain an optical deviation correction coefficient GΦ for a plurality of pixels included in the output image displayed on the projection plane 110. For example, the image projection apparatus 100 (or the processor 410) may obtain the optical deviation correction coefficient GΦ for all of the pixels included in the output image. For example, the image projection apparatus 100 (or the processor 410) may obtain the optical deviation correction coefficient GΦ for specific pixels distributed by each of the partial display regions 731, 733, 735, and 737 in which the output image is displayed. In this case, the image projection apparatus 100 (or the processor 410) may obtain the optical deviation correction coefficient GΦ for each of the partial display regions 731, 733, 735, and 737. The image projection apparatus 100 (or the processor 410) may generate a new LUT by the optical deviation correction coefficient GΦ obtained for each pixel or partial display region. The memory 430 may store a new LUT generated by the image projection apparatus 100 (or the processor 410).

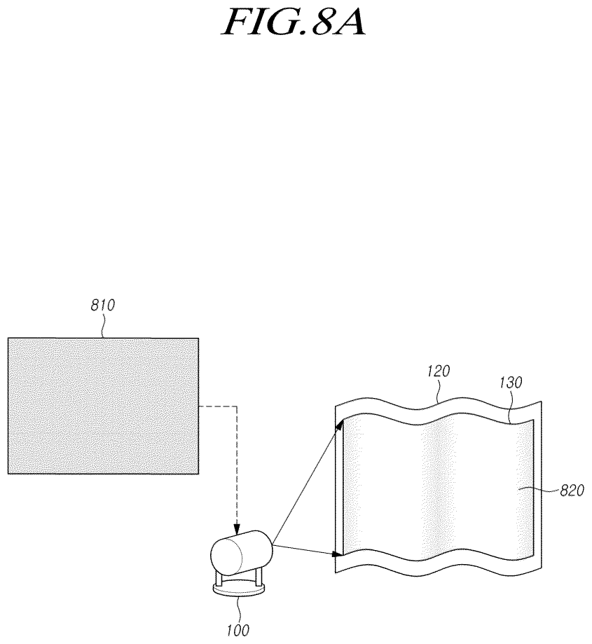

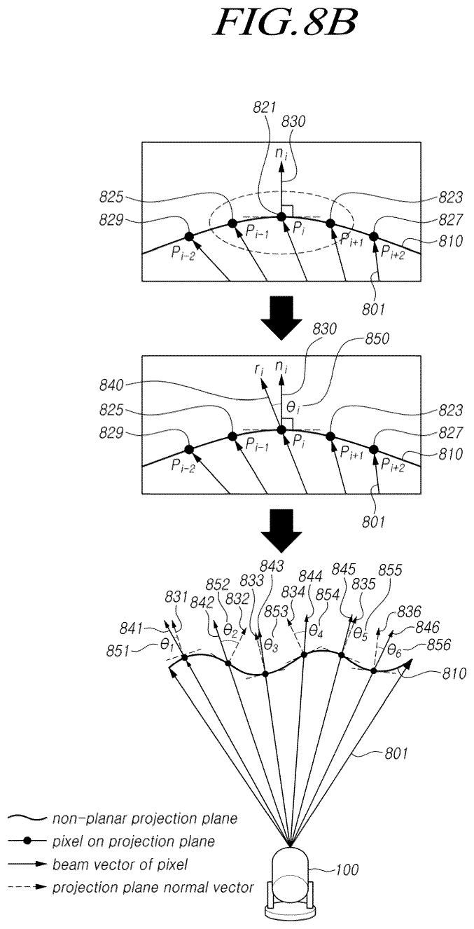

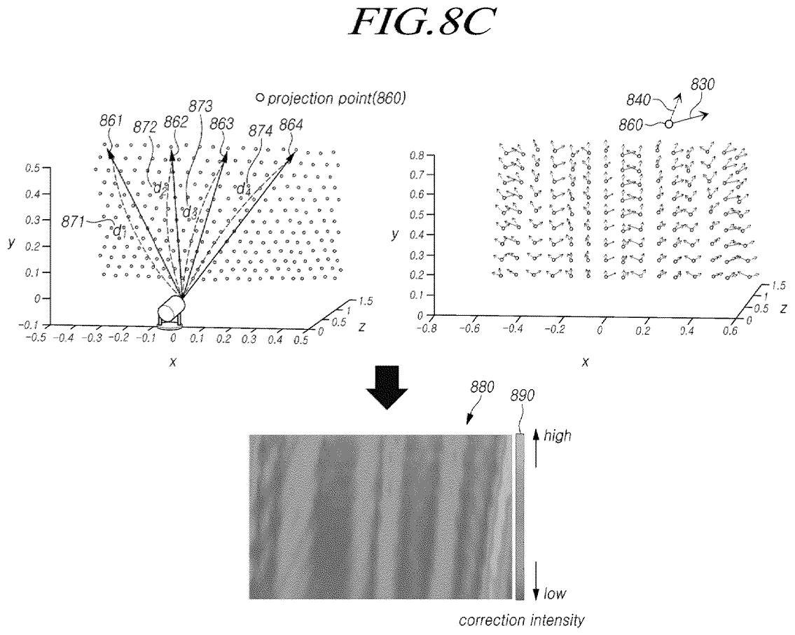

According to an example, data related to characteristic of the projection plane may be stored in the memory 430. The data related to the characteristic of the projection plane may include a projection plane deviation correction coefficient G. The data related to the characteristic of the projection plane may include position data corresponding to a plurality of sensing measurement points obtained by the distance sensor 420. The position data may include, e.g., a space orthogonal coordinate system (e.g., a coordinate value P(x, y, z) corresponding to a position of each of the sensing measurement points in a coordinate space. The position data may include, e.g., an arrival distance d for each sensing measurement point. The position data may include, e.g., the first projection plane deviation correction coefficient Gd obtained considering the arrival distance d for each sensing measurement point. The data related to the characteristic of the projection plane may include an incident angle θi corresponding to the projection beam at the sensing measurement point (e.g., see FIG. 8B). For example, the incident angle θi may be defined by the angle between the vector of the projection beam (hereinafter referred to as a ‘beam vector’) and the normal vector at the corresponding sensing measurement point. The data related to the characteristic of the projection plane may include a second projection plane deviation correction coefficient Gθ obtained considering the incident angle θi for each corresponding projection beam at the sensing measurement points.

The image projector 440 may convert the output image 403 compensated for brightness deviation by the processor 410 into an optical signal 405 to be projected into the projection region 120 of the projection plane 110. The image projector 440 may, e.g., convert the output image 403, which is an electrical signal provided from the processor 410, into an optical signal 405 and transmit it toward the projection region 120. The output image 403, which is an electrical signal provided by the processor 410, may correspond to image data such as a photo or a video. The optical signal 405 projected by the image projector 440 may display an output screen on a screen display region (e.g., the screen display region 130 of FIG. 1) included in the projection region 120. For example, the optical signal 405 transmitted by the image projector 440 may include projection beams. The projection beams respectively may correspond to, e.g., the pixels constituting the output image 403. Accordingly, the projection beams may be projected onto pixel projection points distributed in the projection region 120 to display pixels to constitute the output screen. The pixel projection points may be points where the projection beams transmitted by the image projection apparatus 100 reach the projection region 120. For example, among the projection beams projected at the pixel projection points of the projection region 120, only some projection beams projected on the screen display region 130 may have a color value to substantially display an image.

The processor 410 may execute software to control at least one other component (e.g., a hardware or software component) such as the distance sensor 420 or the image projector 440, which is electrically connected to the processor 410, or may process or compute various data. As at least part of the data processing or computation, the processor 410 may store instructions or data received from other components (e.g., the distance sensor 420, sensor unit 1230, user I/F, or transceiver) in the memory 430 (e.g., volatile memory), or process the instructions or data stored in the memory 430, and store the processed resulting data in the memory 430.

The processor 410 may be implemented as one or more integrated circuit (IC) chips and may perform various data processing. For example, the processor 410 (or an application processor (AP)) may be implemented as a system on chip (SoC) (e.g., one chip or chipset). The processor 410 may include sub components including a central processing unit (CPU), a graphics processing unit (GPU), a neural processing unit (NPU), an image signal processor (ISP), a display controller, a memory controller, a storage controller, a communication processor (CP), and/or a sensor interface. The sub components are merely exemplary. For example, processor 410 may further include other sub components. For example, some sub components may be omitted from the processor 410. For example, some sub components may be included as separate components of the image projection apparatus 100 outside the processor 410. For example, some sub components may be included in other components (e.g., a display and an image sensor).

The processor 410 (e.g., a CPU or a central processing circuit) may be configured to control sub components based on execution of instructions stored in the memory 430 (e.g., a volatile memory and/or a non-volatile memory). According to an example, the GPU (or the graphics processing circuit) included in the processor 410 may be configured to execute parallel computations (e.g., rendering). According to an example, the NPU (or neural processing circuit) included in the processor 410 may be configured to execute operations (e.g., convolution computations) for an artificial intelligence model. According to an example, the ISP (or the image signal processing circuit) included in the processor 410 may be configured to process a raw image obtained through the image sensor into a format suitable for a component in the image projection apparatus 100 or a sub component in the processor 410. According to an example, the display controller (or display control circuit) included in the processor 410 may be configured to process the image 401 obtained from the CPU, GPU, ISP, or memory 430 (e.g., volatile memory) in a suitable format to be projected onto the projection plane (e.g., the projection plane 110 of FIG. 1 or FIG. 2). According to an example, the memory controller (or memory control circuit) included in the processor 410 may be configured to control reading data from volatile memory and writing data to volatile memory. According to an example, the storage controller (or storage control circuit) included in the processor 410 may be configured to control reading data from nonvolatile memory and writing data to nonvolatile memory. According to an example, the CP (communication processing circuit) included in the processor 410 may be configured to process data obtained from a sub component in the processor 410 into a format suitable for transmitting the data to another electronic device through the transceiver (not illustrated), or to process data obtained from another electronic device (e.g., a remote controller) through the transceiver into a format suitable for processing by the sub component. According to an example, the sensor interface (or sensing data processing circuit or sensor hub) included in the processor 410 may be configured to process data about the state of the image projection apparatus 100 and/or the state around the image projection apparatus 100, obtained through an internal sensor (e.g., a distance sensor (time-of-flight (ToF) sensor)) 420 or an external sensor (e.g., one or more position measurement sensors (anchors)), into a format suitable for a sub component in the processor 410.

The processor 410 may generate an output image 403 by performing brightness correction (e.g., the brightness deviation correction 330 of FIG. 3) on the input image 401. The processor 410 may transmit the output image 403 to the image projector 440. The processor 410 may control the image projector 440 to convert the output image 403 into an optical signal 405 and project it toward the projection plane 110. Since the brightness of the optical signal 405 transmitted by the image projector 440 has been corrected, the brightness of the output screen displayed on the screen display region 130 may be uniformly represented as a whole. For example, the processor 410 may perform brightness correction on the input image to enhance the contrast ratio of the output screen. For example, the processor 410 may perform brightness correction to increase the brightness of high-brightness pixels among pixels in the input image and decrease the brightness of low-brightness pixels so that the outline of the image may be clarified in the output image. The processor 410 may perform brightness deviation correction on the input image considering characteristic of the projection lens that may cause optical deviation and/or characteristic of the projection plane 110 regarding the shape and/or curvature of the projection plane 110.

For example, the processor 410 may determine a weight (e.g., a brightness variation coefficient, an optical deviation correction coefficient, and a projection plane deviation correction coefficient) to be applied to input pixels to be projected in a display region (e.g., near the edge or root of the screen display region) that may be displayed darkly on the output screen to be relatively higher than a weight (e.g., a brightness variation coefficient, an optical deviation correction coefficient, and a projection plane deviation correction coefficient) to be applied to input pixels to be projected in a display region (e.g., near the center or crest of the screen display region 130) that may be displayed brightly on the output screen.

For example, the processor 410 may determine a weight (e.g., a brightness variation coefficient, an optical deviation correction coefficient, and a projection plane deviation correction coefficient) to be applied to input pixels to be projected in a display region (e.g., near the center or crest of the screen display region) that may be displayed brightly on the output screen to be relatively lower than a weight (e.g., a brightness variation coefficient, an optical deviation correction coefficient, and a projection plane deviation correction coefficient) to be applied to input pixels to be projected in a display region (e.g., near the edge or root of the screen display region 130) that may be displayed brightly on the output screen.

The processor 410 may perform distortion correction to compensate for image distortion in addition to brightness deviation correction. The processor 410 may generate an output image by performing plane distortion correction such as keystone correction on the input image, e.g., if the projection plane 110 is flat like a screen. When the projection plane 110 is a multi-plane surface, the processor 410 may generate an output image by performing multi-plane distortion correction on the input image. The processor 410 may generate an output image by performing non-planar distortion correction on the input image when the projection plane 110 is non-planar, such as a curved surface. In other words, the processor 410 may perform automatic correction on the input image so that the image displayed on the screen display region 130 may look like a planar image without distortion considering the curvature characteristic of the projection plane 110.

As an example, the processor 410 may determine the brightness variation coefficient δcurve (e.g., the first brightness variation coefficient (δcurve1) 630 of FIG. 6A or the second brightness variation coefficient (δcurve2) 660 of FIG. 6B) corresponding to the input pixel bin or bin′ using the gradation conversion model (e.g., the first gradation conversion model 620 of FIG. 6A or the second gradation conversion model 650 of FIG. 6B). The processor 410 may generate an output pixel bout2 or bout2′ obtained by correcting the brightness deviation of the input pixel bin or bin′ by the brightness variation coefficients 630 and 660. The gradation conversion model 620 or 650 may be set or preset in the production process step of the image projection apparatus 100. One or more gradation conversion models 620 and 650 may be set in the image projection apparatus 100. For example, in the image projection apparatus 100, the gradation conversion model reflecting the characteristic of the projection lens may be set, preset, or registered. For example, the gradation conversion models 620 and 650 to be selectively applied corresponding to the type of content (e.g., movie mode, game mode, or sports mode) may be set or preset or registered in the image projection apparatus 100. For example, the gradation conversion models 620 and 650 to be selectively applied in response to image output modes (e.g., natural images, soft images, bright images, dark images) may be set, preset, or registered in the image projection apparatus 100. In this case, the processor 410 may adjust or change the characteristic of the preset (or the set) gradation conversion models 620 and 650 in response to the user's request. For example, the processor 410 may select and apply the gradation conversion models 620 and 650 suitable for brightness deviation correction in response to a setting related to the user's content type or image output mode.

According to an example, the processor 410 may obtain the optical deviation correction coefficient GΦ which reflects the vignetting characteristic of the lens included in the image projector 440. The processor 410 may obtain, e.g., the optical deviation correction coefficient GΦ corresponding to each of the plurality of partial display regions (e.g., the first to second partial display regions 731, 733, 735, and 737 of FIG. 7A) from a preset lookup table based on the vignetting characteristic. The plurality of partial display regions 731, 733, 735, and 737 may be defined by dividing the projection region 120 based on the change in the vignetting characteristic. For example, the plurality of partial display regions may be areas that may be divided based on a boundary where brightness deviations occur due to the vignetting characteristic of the lens in the projection region 120 (see FIG. 7A). For example, the optical deviation correction coefficient GΦ may have a relatively small value in the first partial display region (e.g., the first partial display region 731 of FIG. 7A) near the center point of the projection region 120 compared to the distant second partial display region (e.g., the second partial display region 733 of FIG. 7A).

According to an example, the processor 410 may obtain an optical deviation correction coefficient GΦ for a specific pixel based on the inter-beam angle Φ1 or Φ2 between a projection beam (e.g., the first projection beam 751 of FIG. 7B) to substantially display the center pixel (e.g., the center pixel 741 of FIG. 7B) of the projection region 120 and a projection beam (e.g., the second projection beam 753 or the third projection beam 755 of FIG. 7B) to display a specific pixel (e.g., the first target pixel 743 or the second target pixel 745 of FIG. 7B), among the display pixels of the projection region 120 (see FIG. 7B). The processor 410 may obtain, e.g., the optical deviation correction coefficient GΦ for all of the pixels in the projection region 120. The processor 410 may obtain, e.g., the optical deviation correction coefficient GΦ for some pixels of the projection region 120. For example, some pixels to obtain the optical deviation correction coefficient GΦ may be a predetermined number of pixels distributed in each partial display region in which a brightness deviation occurs due to the vignetting characteristic. For example, the processor 410 may set a relatively small optical deviation correction coefficient GΦ for the target pixel 743 positioned at a short distance from the center pixel 741 of the projection region 120 and having a small inter-beam angle Φ2, compared to the target pixel 745 positioned at a long distance and having a large inter-beam Φ1.

According to an example, the processor 410 may obtain a projection plane deviation correction coefficient G which reflects the characteristic of the projection plane. The processor 410 may obtain the first projection plane deviation correction coefficient Gd considering, e.g., the arrival distance d for each sensing measurement point (see FIG. 8B). The processor 410 may determine the arrival distance d for each sensing measurement point based on sensing data (e.g., the time difference between the time when the projection beam is transmitted and the time when the projection beam is fed back). For example, the processor 410 may set the optical deviation correction coefficient GΦ that is relatively small for a pixel having a short arrival distance d compared to a pixel having a long arrival distance d. For example, the processor 410 may obtain a second projection plane deviation correction coefficient Gθ considering the incident angle θi for each corresponding projection beam at sensing measurement points (see FIG. 8C). The processor 410 may determine the incident angle θi for each projection beam based on sensing data (e.g., space orthogonal coordinate system of sensing measurement points) obtained by the distance sensor 420. For example, the incident angle θi may be defined as an angle between the beam vector and the normal vector corresponding to the corresponding sensing measurement point. For example, the processor 410 may set a relatively small optical deviation correction coefficient GΦ for a pixel having a small incident angle θi compared to a pixel having a large incident angle θi.

According to an example, the processor 410 may include a data collection module 411, a correction intensity calculation module 413, and/or a pixel brightness adjustment module 415.

The data collection module 411 may collect data necessary to perform brightness correction and/or brightness deviation correction. According to an example, the data collection module 411 may obtain the gradation conversion model to be applied to enhance the contrast ratio considering the characteristic of the projection lens. According to an example, the data collection module 411 may project a single gradation image onto the projection plane 1100, thereby collecting data related to the optical deviation from an image obtained by capturing the output screen displayed on the projection plane 110 by a camera. The data collection module 411 may generate at least one LUT using the collected data related to the optical deviation. The LUT may define the optical deviation correction coefficient GΦ for correcting optical deviation due to the characteristic of the projection lens for each pixel of the output image. According to an example, the data collection module 411 may generate at least one LUT for correcting the brightness deviation (e.g., see FIG. 7A or FIG. 7B) due to the vignetting characteristic of the lens. For example, the LUT may define the optical deviation correction coefficient GΦ for correcting optical deviation due to the vignetting characteristic for each pixel of the output image. For example, the LUT may define the optical deviation correction coefficient GΦ to correct the optical deviation for each partial display region (e.g., the first to second partial display regions 731, 733, 735, and 737 of FIG. 7A) where optical deviation occurs due to the vignetting characteristic in the output image. According to an example, the data collection module 411 may collect data related to characteristic of the projection plane. The data collection module 411 may collect position data corresponding to a plurality of sensing measurement points obtained by the distance sensor 420 as data related to the characteristic of the projection plane. The position data may include, e.g., the space orthogonal coordinate system (e.g., the coordinate value P(x, y, z)) corresponding to the position of each of the sensing measurement points in the coordinate space. The position data may include, e.g., an arrival distance d for each sensing measurement point. The data collection module 411 may determine the first projection plane deviation correction coefficient Gd considering the arrival distance d for each sensing measurement point. According to an example, the data collection module 411 may collect an incident angle θi corresponding to the projection beam at the sensing measurement point as the data related to the characteristic of the projection plane. For example, the incident angle θi may be defined as an angle between the beam vector and the normal vector at the corresponding sensing measurement point. The data collection module 411 may determine the second projection plane deviation correction coefficient Gθ considering the incident angle θi for each projection beam.

The correction intensity calculation module 413 may determine a weight (e.g., the brightness variation coefficient δcurve, the optical deviation correction coefficient GΦ, and the projection plane deviation correction coefficient G) to be applied to each pixel of the input image 401 for brightness correction. For example, the correction intensity calculation module 413 may determine a weight (e.g., the brightness variation coefficient δcurve, the optical deviation correction coefficient GΦ, and the projection plane deviation correction coefficient G) to be applied to pixels to be projected in a display region (e.g., near the edge or root of the screen display region) that may be displayed darkly on the output screen to be relatively higher than a weight (e.g., a brightness variation coefficient, an optical deviation correction coefficient, and a projection plane deviation correction coefficient) to be applied to input pixels to be projected in a display region (e.g., near the center or crest of the screen display region 130) that may be displayed brightly on the output screen. For example, the correction intensity calculation module 413 may determine a weight (e.g., a brightness variation coefficient, an optical deviation correction coefficient, and a projection plane deviation correction coefficient) to be applied to pixels to be projected in a display region (e.g., near the center or crest of the screen display region) that may be displayed brightly on the output screen to be relatively lower than a weight (e.g., the brightness variation coefficient δcurve, the optical deviation correction coefficient GΦ, and the projection plane deviation correction coefficient G) to be applied to pixels to be projected in a display region (e.g., near the edge or root of the screen display region 130) that may be displayed brightly on the output screen.

According to an example, the correction intensity calculation module 413 may determine the brightness change coefficient δcurve to be applied for each pixel when brightness is corrected for the input image using the gradation conversion model (e.g., the first gradation conversion model 620 of FIG. 6A or the second gradation conversion model 650 of FIG. 6B). The gradation conversion model may define a brightness variation coefficient δcurve (e.g., the first brightness variation coefficient (δcurve1) 630 of FIG. 6A or the second brightness variation coefficient (δcurve2) 660 of FIG. 6B) for correcting the brightness in order to enhance the contrast ratio for each input pixel brightness Bin(i) (see FIG. 6A or FIG. 6B). The gradation conversion model may be modeled to enhance the contrast ratio considering, e.g., the characteristic of the projection lens. The gradation conversion model may be modeled to be selectively applied in response to, e.g., a content type (e.g., a movie mode, a game mode, or a sports mode). The gradation conversion model may be modeled to be selectively applied in response to, e.g., an image output mode (e.g., a natural image, a soft image, a bright image, a dark image).

For example, the brightness variation coefficient may be determined based on a difference (e.g., Bout(i)−Bin(i)) between the input pixel brightness and the output pixel brightness Bout(i) to be obtained. For example, if the correction intensity calculation module 413 knows the input pixel brightness for a specific pixel, the brightness variation coefficient may be obtained from the gradation conversion model 620 or 650. For example, the correction intensity calculation module 413 may obtain brightness variation coefficients for all of the pixels of the input image 401 using the gradation conversion model 620 or 650. For example, the correction intensity calculation module 413 may obtain a brightness variation coefficient for some pixels of the input image 401 using the gradation conversion model 620 or 650, and may predict a brightness variation for the remaining pixels based on the brightness variation coefficient obtained for some pixels. The correction intensity calculation module 413 may determine a brightness variation coefficient for each pixel so that brightness correction may be performed for each pixel of the input image 401. In this case, the brightness of the output pixel may be differentially adjusted for each pixel. For example, the correction intensity calculation module 413 may determine the brightness variation coefficient to be applied to the input pixel brightness of a specific gradation to be relatively higher or lower than the brightness variation coefficient to be applied to the input pixel brightness of another gradation.

According to an example, the correction intensity calculation module 413 may determine an optical deviation correction coefficient to correct the brightness deviation of the input image 401 considering a characteristic (e.g., vignetting characteristic) of a lens where the optical signal 405 converted from the output image 403 is to be projected. If the optical deviation of the corresponding lens due to a cause such as the vignetting characteristic is known, the correction intensity calculation module 413 may determine an optical deviation correction coefficient to differentially correct the brightness deviation for each corresponding pixel and/or corresponding partial area considering the optical deviation. For example, the correction intensity calculation module 413 may determine the optical deviation correction coefficient to be applied to pixels to be projected near the center of the screen to be relatively higher or lower than the optical deviation correction coefficient to be applied to pixels to be projected near the edge.

According to an example, the correction intensity calculation module 413 may determine a projection plane deviation correction coefficient to correct the brightness deviation of the input image 401 considering the characteristic (e.g., curvature characteristic due to non-planarity) related to the projection plane 110. For example, the characteristic of the projection plane 110 may be the arrival distance of the projection beam transmitted by the image projection apparatus 100 to the projection plane 110 and/or the incident angle on the projection plane 110 due to the direction of the beam transmitted by the image projection apparatus 100. For example, the arrival distance or incident angle for each pixel may differ according to the type of projection plane 110 (e.g., plane, multi-plane, or non-plane). If the arrival distance or incident angle for each pixel is known, the correction intensity calculation module 413 may determine a deviation correction coefficient for differentially correcting the brightness deviation for each pixel and/or the corresponding partial area considering the arrival distance or incident angle for each pixel. For example, the correction intensity calculation module 413 may determine a deviation correction coefficient to be applied to pixels with a shorter arrival distance to be relatively higher than a deviation correction coefficient to be applied to pixels with a longer arrival distance. For example, the correction intensity calculation module 413 may determine a deviation correction coefficient to be applied to pixels with a longer arrival distance to be relatively lower than a deviation correction coefficient to be applied to pixels with a shorter arrival distance. For example, the correction intensity calculation module 413 may determine a deviation correction coefficient to be applied to pixels with a larger incident angle to be relatively higher than a deviation correction coefficient to be applied to pixels with a smaller incident angle. For example, the correction intensity calculation module 413 may determine a deviation correction coefficient to be applied to pixels with a smaller incident angle to be relatively lower than a deviation correction coefficient to be applied to pixels with a larger incident angle.

The pixel brightness adjustment module 415 may perform brightness correction and/or brightness deviation correction on the input image by applying at least one of the brightness variation coefficient, the optical deviation correction coefficient, and the projection plane deviation correction coefficient obtained by the correction intensity calculation module 413. The pixel brightness adjustment module 415 transmits the output image 403 generated through brightness correction and/or brightness deviation correction to the image projector 440 so that the optical signal 405 is transmitted. The output image 403 generated through brightness correction and/or brightness deviation correction causes an output image having a consistent brightness as a whole to be displayed in the projection region 120.

According to an example, the image projection apparatus 100 may include additional components such as a user interface (I/F). For example, the user I/F may be configured to receive information from the user. The user I/F may receive a command or data to be used by other component (e.g., the processor 410) of the image projection apparatus 100, from the outside (e.g., a user) of the image projection apparatus 100. The user I/F may include, e.g., a microphone, a mouse, a keyboard, a key (e.g., a button), a remote controller, or a digital pen (e.g., a stylus pen). According to an example, the user I/F may be configured to transfer information to the user. The user I/F may output sound signals to the outside of the image projection apparatus 100 through a component such as a speaker. For example, the speaker may be used for general purposes, such as playing multimedia or playing record.

According to an example, the image projection apparatus 100 may include an additional component, such as a transceiver. The transceiver 840 may be configured to exchange information with at least one electronic device. The transceiver may transmit/receive data or signals with a remote controller or external sensors under the control of the processor 410.

According to an example, the transceiver may include, but is not limited to, a Bluetooth communication unit, a Bluetooth™ low energy (BLE) communication unit, a near field communication unit, a WLAN (Wi-Fi) communication unit, a Zigbee communication unit, an infrared data association (IrDA) communication unit, a Wi-Fi direct (WFD) communication unit, an ultra-wideband (UWB) communication unit, an Ant+ communication unit, or a microwave (uWave) communication unit, corresponding to the performance and structure of the image projection apparatus 100.

According to an example, the transceiver may support establishing a direct (e.g., wired) communication channel or a wireless communication channel with a remote controller and performing communication through the established communication channel. The transceiver may include one or more CPs supporting direct (e.g., wired) communication or wireless communication. The one or more CPs may be operated independently of the processor 410. The transceiver may include, e.g., a wireless communication module (e.g., a cellular communication module, a short-range wireless communication module, or a global navigation satellite system (GNSS) communication module) or a wired communication module (e.g., a local area network (LAN) communication module or a power line communication module). A corresponding one of these communication modules may communicate with at least one remote controller, which is an external electronic device, via a network (e.g., a short-range communication network, such as Bluetooth™, wireless-fidelity (Wi-Fi) direct, or infrared data association (IrDA)) or a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other.

According to an example, the image projection apparatus 100 may include an external sensor, as an external component. The sensing data obtained through the external sensor may include information to be used to obtain the position of the image projection apparatus 100. The sensing data obtained through the external sensor may include information to be used to obtain the position of the viewer (e.g., the viewer 125 of FIG. 1). The image projection apparatus 100 may predict the viewpoint at which the viewer 125 views the projection plane 110 considering the position of the viewer 125 obtained based on the sensing data. The processor 410 may identify the position of the image projection apparatus 100 using the sensing data.

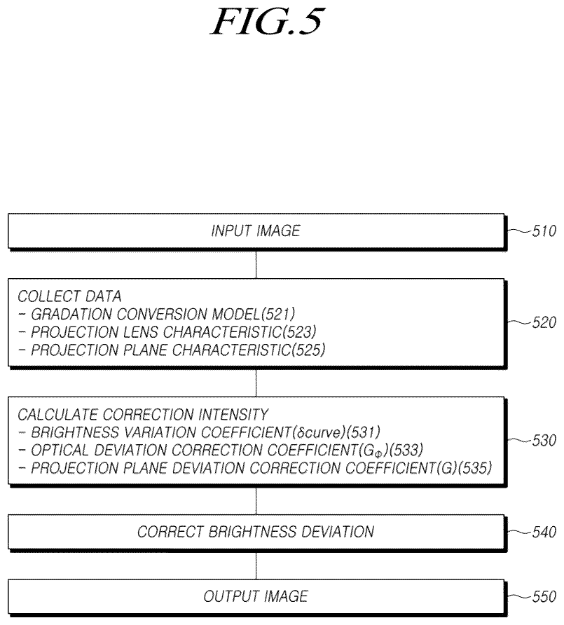

FIG. 5 is a control flowchart for obtaining position data of an area (e.g., the projection region 120 of FIG. 1 or 2) to project image data in an image projection apparatus (e.g., the image projection apparatus 100 of FIG. 1) according to an embodiment.

In the following embodiment, each operation may be sequentially performed, but is not necessarily performed sequentially. For example, the order of the operations may be changed, and at least two operations may be performed in parallel.

Referring to FIG. 5, in operation 510, the image projection apparatus 100 may receive image data. The video data may be input according to a content service such as a movie or a game, for example.

In operation 520, the image projection apparatus 100 may collect data necessary to perform brightness correction and/or brightness deviation correction. According to an example, the image projection apparatus 100 may obtain a gradation conversion model to be applied to enhance the contrast ratio considering the characteristic of the projection lens. According to an example, the image projection apparatus 100 may project a single gradation image onto the projection plane 1100, thereby collecting data related to the optical deviation from an image obtained by capturing the output screen displayed on the projection plane 110 by a camera. The image projection apparatus 100 may generate at least one LUT using the collected data related to the optical deviation. The LUT may define the optical deviation correction coefficient GΦ for correcting optical deviation due to the characteristic of the projection lens for each pixel of the output image. According to an example, the image projection apparatus 100 may generate at least one LUT for correcting the brightness deviation (e.g., see FIG. 7A or FIG. 7B) due to the vignetting characteristic of the lens. For example, the LUT may define the optical deviation correction coefficient GΦ for correcting optical deviation due to the vignetting characteristic for each pixel of the output image. For example, the LUT may define the optical deviation correction coefficient GΦ to correct the optical deviation for each partial display region (e.g., the first to second partial display regions 731, 733, 735, and 737 of FIG. 7A) where optical deviation occurs due to the vignetting characteristic in the output image. According to an example, the image projection apparatus 100 may collect data related to characteristic of the projection plane. The image projection apparatus 100 may collect position data corresponding to a plurality of sensing measurement points obtained by the distance sensor 420 as data related to the characteristic of the projection plane. The position data may include, e.g., the space orthogonal coordinate system (e.g., the coordinate value P(x, y, z)) corresponding to the position of each of the sensing measurement points in the coordinate space. The position data may include, e.g., an arrival distance d for each sensing measurement point. The image projection apparatus 100 may determine the first projection plane deviation correction coefficient Gd considering the arrival distance d for each sensing measurement point. According to an example, the image projection apparatus 100 may collect an incident angle θi corresponding to the projection beam at the sensing measurement point as the data related to the characteristic of the projection plane. For example, the incident angle θi may be defined as an angle between the beam vector and the normal vector at the corresponding sensing measurement point. The data collection module 411 may determine the second projection plane deviation correction coefficient Gθ considering the incident angle θi for each projection beam.

In operation 530, the image projection apparatus 100 may determine a weight (e.g., the brightness variation coefficient δcurve, the optical deviation correction coefficient GΦ, and the projection plane deviation correction coefficient G) to be applied to each pixel of the input image 401 for brightness correction. For example, the image projection apparatus 100 may determine a weight (e.g., the brightness variation coefficient δcurve, the optical deviation correction coefficient GΦ, and the projection plane deviation correction coefficient G) to be applied to pixels to be projected in a display region (e.g., near the edge or root of the screen display region) that may be displayed darkly on the output screen to be relatively higher than a weight (e.g., a brightness variation coefficient, an optical deviation correction coefficient, and a projection plane deviation correction coefficient) to be applied to input pixels to be projected in a display region (e.g., near the center or crest of the screen display region 130) that may be displayed brightly on the output screen. For example, the image projection apparatus 100 may determine a weight (e.g., a brightness variation coefficient, an optical deviation correction coefficient, and a projection plane deviation correction coefficient) to be applied to pixels to be projected in a display region (e.g., near the center or crest of the screen display region) that may be displayed brightly on the output screen to be relatively lower than a weight (e.g., the brightness variation coefficient δcurve, the optical deviation correction coefficient GΦ, and the projection plane deviation correction coefficient G) to be applied to pixels to be projected in a display region (e.g., near the edge or root of the screen display region 130) that may be displayed brightly on the output screen.

According to an example, the image projection apparatus 100 may determine the brightness change coefficient δcurve to be applied for each pixel when brightness is corrected for the input image using the gradation conversion model (e.g., the first gradation conversion model 620 of FIG. 6A or the second gradation conversion model 650 of FIG. 6B). The gradation conversion model may define a brightness variation coefficient δcurve (e.g., the first brightness variation coefficient (δcurve1) 630 of FIG. 6A or the second brightness variation coefficient (δcurve2) 660 of FIG. 6B) for correcting the brightness in order to enhance the contrast ratio for each input pixel brightness Bin(i) (see FIG. 6A or FIG. 6B). The gradation conversion model may be modeled to enhance the contrast ratio considering, e.g., the characteristic of the projection lens. The gradation conversion model may be modeled to be selectively applied in response to, e.g., a content type (e.g., a movie mode, a game mode, or a sports mode). The gradation conversion model may be modeled to be selectively applied in response to, e.g., an image output mode (e.g., a natural image, a soft image, a bright image, a dark image).

For example, the brightness variation coefficient δcurve may be determined based on a difference (e.g., Bout(i)−Bin(i)) between the input pixel brightness Bin(i) and the output pixel brightness Bout(i) to be obtained. For example, if the image projection apparatus 100 knows the input pixel brightness for a specific pixel, the brightness variation coefficient may be obtained from the gradation conversion model 620 or 650. For example, the image projection apparatus 100 may obtain brightness variation coefficients for all of the pixels of the input image 401 using the gradation conversion model 620 or 650. For example, the image projection apparatus 100 may obtain a brightness variation coefficient for some pixels of the input image 401 using the gradation conversion model 620 or 650, and may predict a brightness variation for the remaining pixels based on the brightness variation coefficient obtained for some pixels. The image projection apparatus 100 may determine a brightness variation coefficient for each pixel so that brightness correction may be performed for each pixel of the input image 401. In this case, the brightness of the output pixel may be differentially adjusted for each pixel. For example, the image projection apparatus 100 may determine the brightness variation coefficient to be applied to the input pixel brightness of a specific gradation to be relatively higher or lower than the brightness variation coefficient to be applied to the input pixel brightness of another gradation.

According to an example, the image projection apparatus 100 may determine an optical deviation correction coefficient GΦ to correct the brightness deviation of the input image 401 considering a characteristic (e.g., vignetting characteristic) of a lens where the optical signal 405 converted from the output image 403 is to be projected. If the optical deviation of the corresponding lens due to a cause such as the vignetting characteristic is known, the image projection apparatus 100 may determine an optical deviation correction coefficient to differentially correct the brightness deviation for each corresponding pixel and/or corresponding partial area considering the optical deviation. For example, the image projection apparatus 100 may determine the optical deviation correction coefficient to be applied to pixels to be projected near the center of the screen to be relatively higher or lower than the optical deviation correction coefficient to be applied to pixels to be projected near the edge.

According to an example, the image projection apparatus 100 may determine a brightness correction coefficient G to correct the brightness deviation of the input image 401 considering the characteristic (e.g., curvature characteristic due to non-planarity) related to the projection plane 110. For example, the characteristic of the projection plane 110 may be the arrival distance of the projection beam transmitted by the image projection apparatus 100 to the projection plane 110 and/or the incident angle on the projection plane 110 due to the direction of the beam transmitted by the image projection apparatus 100. For example, the arrival distance or incident angle for each pixel may differ according to the type of projection plane 110 (e.g., plane, multi-plane, or non-plane). If the arrival distance or incident angle for each pixel is known, the image projection apparatus 100 may determine a brightness correction coefficient G for differentially correcting the brightness deviation for each pixel and/or the corresponding partial area considering the arrival distance or incident angle for each pixel.

According to an example, the image projection apparatus 100 may determine the second projection plane deviation correction coefficient Gθ to be applied to the pixels with a larger incident angle θ to be relatively higher than the second projection plane deviation correction coefficient Gθ to be applied to the pixels with a smaller incident angle θ. For example, the image projection apparatus 100 may determine the second projection plane deviation correction coefficient Gθ to be applied to the pixels with a smaller incident angle θ to be relatively lower than the second projection plane deviation correction coefficient Gθ to be applied to the pixels with a larger incident angle θ. For example, the image projection apparatus 100 may determine the second projection plane deviation correction coefficient Gθ by ‘(1−cos(θ))α′.

According to an example, the image projection apparatus 100 may determine a deviation correction coefficient to be applied to pixels with a shorter arrival distance to be relatively higher than a deviation correction coefficient to be applied to pixels with a longer arrival distance. For example, the image projection apparatus 100 may determine a deviation correction coefficient to be applied to pixels with a longer arrival distance to be relatively lower than a deviation correction coefficient to be applied to pixels with a shorter arrival distance. For example, the image projection apparatus 100 may determine the first projection plane deviation correction coefficient Gd as the square d2 of the arrival distance d.

According to an example, the image projection apparatus 100 may determine a deviation correction coefficient for differentially correcting the brightness deviation for each pixel and/or the corresponding partial area based on an arbitrary distribution (Φ=N(μ,σ2) centered on a reference point (e.g., the center point of the brightness distribution of the output screen or the center point of the output screen).

According to an example, the image projection apparatus 100 may determine a weight to be applied to each pixel of the input image 401 for brightness correction using the previously determined brightness variation coefficient δcurve, optical deviation correction coefficient GΦ, the first projection plane deviation correction coefficient Gd, and the second projection plane deviation correction coefficient Gθ. For example, the image projection apparatus 100 may determine the weight by ‘δcurve×GΦ×Gθ×Gd′.

In operation 540, the image projection apparatus 100 may perform brightness correction and/or brightness deviation correction on the pixels of the input image 401 by applying the weight (‘δcurve×GΦ×Gθ×Gd′) to be applied to each pixel of the input image 401 for brightness correction.

In operation 550, the image projection apparatus 100 may convert the output image 403 generated through brightness correction and/or brightness deviation correction into an optical signal 405 and transmit the same through the image projector 440. The output image 403 generated through brightness correction and/or brightness deviation correction causes an output image having a consistent brightness as a whole to be displayed in the projection region 120.

FIG. 6A is a view illustrating brightness deviation correction for increasing the brightness of input pixels using a gradation conversion model. FIG. 6B is a view illustrating brightness deviation correction for decreasing the brightness of input pixels using a gradation conversion model. FIG. 6C is a view illustrating brightness correction using a gradation conversion model.

The first gradation conversion model 620 of FIG. 6A is modeled to increase the input pixel brightness, and the second gradation conversion model 650 of FIG. 6B is modeled to decrease the input pixel brightness.

Referring to FIG. 6A, the first gradation conversion model 620 is designed to perform differential brightness deviation correction to increase the brightness of each gradation of input pixel brightness. For example, the first gradation conversion model 620 applies a relatively high brightness variation coefficient (δcurve) 630 to relatively high gradations compared to an intermediate gradation, and a relatively low brightness variation coefficient (δcurve) 630 to relatively low gradations. Here, the brightness variation coefficient (δcurve) 630 may be defined as a difference value between the first output pixel brightness bout1 that may be obtained when the reference graph 610 is applied to a specific input pixel brightness bin and the second output pixel brightness bout2 that may be obtained when the graph 620 corresponding to the first gradation conversion model is applied. In this case, the first output pixel brightness bout′ may be higher than the second output pixel brightness bout2 by the brightness variation coefficient (δcurve) 630.

Referring to FIG. 6B, the second gradation conversion model 650 is designed to perform differential brightness deviation correction to reduce the brightness of each gradation of input pixel brightness. For example, the second gradation conversion model 650 applies a relatively high brightness variation coefficient (δcurve′) 660 to relatively high gradations compared to an intermediate gradation, and a relatively low brightness variation coefficient (δcurve′) 660 to relatively low gradations. Here, the brightness variation coefficient (δcurve′) 660 may be defined as a difference value between the first output pixel brightness bout1′ that may be obtained when the reference graph 640 is applied to a specific input pixel brightness bin and the second output pixel brightness bout2′ that may be obtained when the graph 650 corresponding to the second gradation conversion model is applied. In this case, the first output pixel brightness bout1′ may be lower than the second output pixel brightness bout2′ by the brightness variation coefficient δcurve′ 660.

Referring to FIG. 6C, the image projection apparatus (e.g., the image projection apparatus 100 of FIG. 1) may generate an output image by correcting the brightness of the input pixels of the input image 670 based on the gradation conversion model (e.g., the first gradation conversion model 620 of FIG. 6A). Objects (e.g., the sun 671, the roof 673, and the wall 675) included in the input image 670 illustrated on the upper side may have different brightness values. The image projection apparatus 100 may obtain a correction intensity to be applied to each object having different brightness values in the input image 670 based on the gradation conversion model 620. The correction intensity image 680 illustrated on the lower side shows the correction intensities corresponding to the objects (e.g., the sun 671, the roof 673, and the wall 675) included in the input image 670. For example, the sun 671 has the highest brightness value, the wall 675 has an intermediate brightness value, and the roof 673 has the darkest brightness value in the input image 670. The image projection apparatus 100 may allocate a low correction intensity (e.g., the lowest correction intensity in a gradation bar) 681 to the brightest sun 671 based on the gradation conversion model 620 so that the brightness variation may be the smallest after correction. The image projection apparatus 100 may allocate an intermediate correction intensity (e.g., an intermediate correction intensity in the gradation bar) 685 to the wall 675 having the intermediate brightness value based on the gradation conversion model 620 so that the brightness variation may be an intermediate after correction. The image projection apparatus 100 may allocate a low correction intensity (e.g., a relatively low correction intensity in the gradation bar) 683 to the darkest roof 673 based on the gradation conversion model 620 so that the brightness variation is not large after correction. For example, it may be identified that a low correction intensity of the brightness deviation may be allocated so that the brightness variation is relatively small for a particular object (e.g., the sun 671 or the roof 673) that is very bright or very dark in the input image 670.

FIGS. 7A and 7B are views illustrating obtaining an optical deviation correction coefficient considering a vignetting characteristic of a lens.

In FIG. 7A, brightness deviations occur in four partial display regions due to the vignetting phenomenon, but this is merely an example, and the optical deviation correction coefficient may be determined equally or similarly for more or fewer partial display regions.

Referring to FIG. 7A, the image projection apparatus 100 may obtain an optical deviation correction coefficient reflecting the vignetting characteristic of the lens included in the image projector (e.g., the image projector 440 of FIG. 4). The vignetting phenomenon is a phenomenon which light is not completely transmitted to the edges 720a, 720b, 720c, and 720d of the projection region 120 due to refraction that occurs when the optical signal 405 passes through the lens. As a result, the brightness of the edges 720a, 720b, 720c, and 720d may be displayed darker than the center 710 on the output screen which the optical signal (e.g., the optical signal 405 of FIG. 4) transmitted by the image projection apparatus 100 is projected on the projection plane (e.g., the projection plane 110 of FIG. 1).

The image projection apparatus 100 may perform brightness deviation correction on the input pixel to correct brightness deviation occurring on the output screen due to the vignetting phenomenon. According to an example, the image projection apparatus 100 may preset the LUT based on the vignetting characteristic. For example, in the LUT, the optical deviation correction coefficient GΦ for correcting optical deviation due to the characteristic of the projection lens may be defined for each pixel of the input image. For example, the LUT may define an optical deviation correction coefficient GΦ for correcting the optical deviation for each partial display region 731, 733, 735, and 737 in which optical deviation due to the vignetting characteristic occurs in the output image. For example, the optical deviation correction coefficient GΦ 737 may be determined to be relatively high so that brightness deviation may be corrected by a relatively high correction intensity for the edges 720a, 720b, 720c, and 720d where brightness may be relatively dark due to the vignetting phenomenon. For example, the optical deviation correction coefficient GΦ 731 may be determined to be relatively low so that brightness deviation may be corrected by a relatively low correction intensity for the center 710 where brightness is relatively bright due to the vignetting phenomenon. For example, since the brightness becomes relatively dark away from the center 710 due to the vignetting phenomenon, the optical deviation correction coefficient (GΦ) 733, 735 may be determined so that brightness deviation may be corrected by a relatively higher correction intensity.

Referring to FIG. 7B, the image projection apparatus 100 may obtain the inter-beam angle Φ1 or Φ2 between a projection beam (e.g., the first projection beam 751 of FIG. 7B) to substantially display the center pixel (e.g., the center pixel 741 of FIG. 7B) of the projection region 120 and a projection beam (e.g., the second projection beam 753 or the third projection beam 755 of FIG. 7B) to display a specific pixel (e.g., the first target pixel 743 or the second target pixel 745 of FIG. 7B), among the display pixels of the projection region 120. The image projection apparatus 100 may determine an optical deviation correction coefficient for the corresponding pixel based on the inter-beam angle Φ1 or Φ2 obtained for each of the specific pixels 743 and 745. The image projection apparatus 100 may obtain, e.g., optical deviation correction coefficients for all of the pixels in the projection region 120. The image projection apparatus 100 may obtain, e.g., an optical deviation correction coefficient for some pixels of the projection region 120. For example, some pixels to obtain the optical deviation correction coefficient may be a predetermined number of pixels distributed in each partial display region where brightness deviation occurs due to the vignetting phenomenon. For example, a relatively small optical deviation correction coefficient GΦ may be determined for the target pixel 743 positioned at a short distance from the center pixel 741 of the projection region 120 and having a small inter-beam angle Φ2, compared to the target pixel 745 positioned at a long distance and having a large inter-beam Φ1.

For example, a relatively large optical deviation correction coefficient GΦ may be determined for the target pixel 745 positioned at a long distance from the center pixel 741 of the projection region 120 and having a large inter-beam angle Φ1, compared to the target pixel 743 positioned at a short distance and having a small inter-beam Φ2. For example, an optical deviation correction coefficient (GΦ) 751, 753, 755 corresponding to a relatively high correction intensity may be allocated away from the center pixel 741.

FIG. 8A is a view illustrating that a brightness deviation occurs in a non-planar projection plane (e.g., the projection plane 110 of FIG. 1) according to an incident angle of a projection beam. FIG. 8B is a view illustrating compensating for a brightness deviation using a second projection plane deviation correction coefficient Gθ obtained considering an incident angle θ for each sensing measurement point. FIG. 8C is a view illustrating compensating for brightness deviation using a first projection plane deviation correction coefficient Gd obtained considering an arrival distance d for each sensing measurement point.

Referring to FIG. 8A, the image projection apparatus 100 may project an output image (e.g., the output image 403 of FIG. 4) generated without brightness correction (e.g., the brightness deviation correction 330 of FIG. 3) for the input image 810 (e.g., input image 401) onto the projection region 120 and display the output screen 820 on the screen display region 130. In this case, a deviation may occur in the brightness of the corresponding pixel on the output screen 820 according to the incident angle θ where the projection beam is projected onto the projection region 120. For example, as the projection beam is obliquely incident on the projection region 120, the intensity of reflected light may decrease. In other words, the intensity of light reflected from the projection plane 110 may have a different attenuation amount according to the incident angle of the projection beam. As a result, the brightness deviation that occurs causes an output screen 820 having an uneven brightness to be displayed.

Referring to FIG. 8B, the image projection apparatus 100 may determine the second projection plane deviation correction coefficient Gθ for the corresponding pixel if the incident angles θ1 851, 02 852, 03 853, 04 854, 05 855, and 06 856 may be obtained for each projection beam 801 or pixel projection point 821, 823, 825, 827, and 829. For example, a specific incident angle θi 850 may be determined by the angle between the beam vector ri 840 of the corresponding projection beam 801 and the normal vector ni 830 at the corresponding pixel projection point 821. The remaining incident angles θ1 851, 02 852, 03 853, 04 854, 05 855, and 06 856 may also be determined by the beam vectors 841, 842, 843, 844, 845, and 846 and the normal vectors 831, 832, 833, 834, 835, and 836 at the corresponding pixel projection points 821, 823, 825, 827, and 829. The image projection apparatus 100 may allocate a relatively small second optical deviation correction coefficient GΦ to a pixel having a small incident angle θi, compared to a pixel having a large incident angle θi. For example, the image projection apparatus 100 may determine the second projection plane deviation correction coefficient Gθ by ‘(1−cos(θ))α’.

Referring to FIG. 8C, the image projection apparatus 100 may determine the first projection plane deviation correction coefficient Gd for the corresponding pixel if the arrival distances d1 871, d2 872, d3 873, and d4 874 for each of the projection beams 861, 862, 863, and 864 projected at the pixel projection point may be obtained. The image projection apparatus 100 may allocate a small first optical deviation correction coefficient Gd corresponding to a relatively low correction intensity to a pixel having a short arrival distance, compared to a pixel having a long arrival distance. The image projection apparatus 100 may allocate a large first optical deviation correction coefficient Gd corresponding to a relatively high correction intensity to a pixel having a long arrival distance, compared to a pixel having a short arrival distance. For example, the image projection apparatus 100 may determine the first projection plane deviation correction coefficient Gd by ‘d2’.

As described above, when the first projection plane deviation correction coefficient Gd and the second projection plane deviation correction coefficient Gθ are determined, the image projection apparatus 100 may determine the projection plane deviation correction intensity, i.e., the projection plane deviation correction coefficient, by the determined first projection plane deviation correction coefficient Gd and the second projection plane deviation correction coefficient Gθ. For example, the product (Gd×Gθ) of the first projection plane deviation correction coefficient Gd and the second projection plane deviation correction coefficient Gθ may be determined as the projection plane deviation correction intensity, i.e., the projection plane deviation correction coefficient, corresponding to the pixel. The image projection apparatus 100 may adjust the output pixel brightness by performing brightness correction for the input pixel brightness by the projection plane deviation correction intensity determined for each pixel. The output image by the output pixels whose brightness is adjusted may be displayed as the output screen 880 in the projection region 120. In FIG. 8C, the lower view is a visual representation of the deviation correction intensity 890 corresponding to the output screen displayed in the projection region 120.

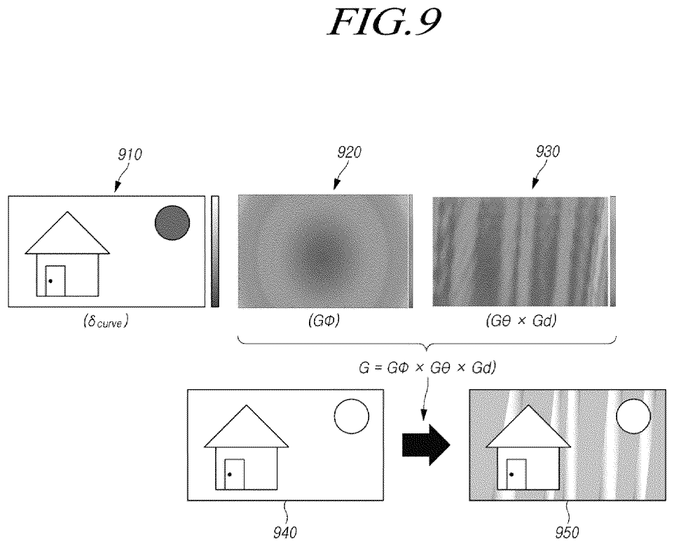

FIG. 9 is a view illustrating an operation of generating an output image 950 by applying a weight (e.g., a brightness variation coefficient (δcurve) 910, the optical deviation correction coefficient GΦ 920, and a brightness correction coefficient (G) 930) to an input image 940 to perform brightness compensation and/or brightness deviation compensation.

Referring to FIG. 9, the image projection apparatus (e.g., the image projection apparatus 100 of FIG. 1) may obtain the brightness variation coefficient (δcurve) 910 for each pixel of the input image 940 using a specific gradation conversion model. The image projection apparatus 100 may obtain the optical deviation correction coefficient GΦ 920 for each pixel of the input image 940 considering the optical deviation, which is a characteristic of the projection lens.

The image projection apparatus 100 may obtain the second projection plane deviation correction coefficient Gθ for each pixel of the input image 940 considering the incident angle θ, which is a characteristic of the projection plane. The image projection apparatus 100 may obtain the first projection plane deviation correction coefficient Gd for each pixel of the input image 940 considering the arrival distance d, which is a characteristic of the projection plane.

The image projection apparatus 100 may determine the weight (δcurve×GΦ×Gθ×Gd′) to be applied to each pixel of the input image 401 for brightness correction. The image projection apparatus 100 may perform brightness correction and/or brightness deviation correction on the corresponding input pixel using the weight (δcurve×GΦ×Gθ×Gd′) determined for each input pixel. The image projection apparatus 100 may generate an output image 950 by performing brightness correction and/or brightness deviation correction for each input pixel.

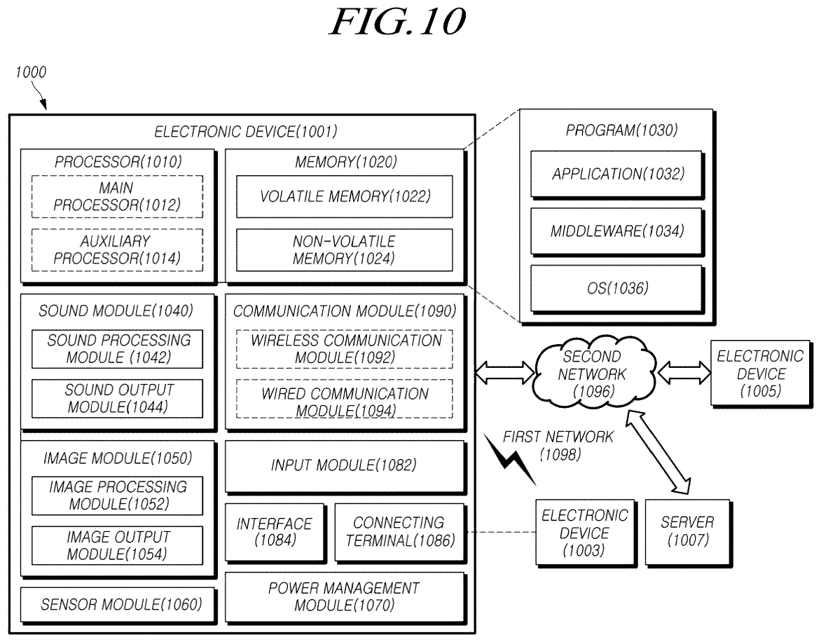

FIG. 10 is a block diagram illustrating an electronic device 1001 (e.g., the image projection apparatus 100 of FIG. 2) in a network environment 1000 according to one or more embodiments.

Referring to FIG. 10, the electronic device 1001 in the network environment 1000 may communicate with at least one of an electronic device 1003 via a first network 1098 (e.g., a short-range wireless communication network), or an electronic device 1005 or a server 1007 via a second network 1096 (e.g., a long-range wireless communication network). According to an example, the electronic device 1001 may communicate with the electronic device 1005 via the server 1007. According to an example, the electronic device 1001 may include a processor 1010, memory 1020, a sound module 1040, an image module 1050, a sensor module 1060, a power management module 1070, an input module 1082, an interface 1084, a connecting terminal 1086, or a communication module 1090. In an example, at least one (e.g., the input module 1082) of the components may be omitted from the electronic device 1001, or one or more other components may be added in the electronic device 101. In an example, some of these components may be integrated into one component.

The processor 1010 may execute, for example, software (e.g., a program 1030) to control at least one other component (e.g., a hardware or software component) of the electronic device 1001 coupled with the processor 1010, and may perform various data processing or computation. According to an example, as at least part of the data processing or computation, the processor 1010 may store a command or data received from another component (e.g., the sensor module 1060 or the communication module 1090) in volatile memory 1022, process the command or the data stored in the volatile memory 1022, and store resulting data in non-volatile memory 1024. According to an example, the processor 1010 may include a main processor 1012 (e.g., a central processing unit (CPU) or an application processor (AP)), or an auxiliary processor 1014 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 1001 includes the main processor 1012 and the auxiliary processor 1014, the auxiliary processor 1014 may be configured to use lower power than the main processor 1012 or to be specified for a designated function. The auxiliary processor 1014 may be implemented as separate from, or as part of the main processor 1012.

The auxiliary processor 1014 may control at least some of functions or states related to at least one component (e.g., the sensor module 1060 or the communication module 1090) among the components of the electronic device 1001, instead of the main processor 1012 while the main processor 1012 is in an inactive (e.g., sleep) state, or together with the main processor 1012 while the main processor 1012 is in an active state (e.g., executing an application). According to an example, the auxiliary processor 1014 (e.g., an image signal processor or a communication processor) may be implemented as part of another component (e.g., the communication module 1090) functionally related to the auxiliary processor 123. According to an example, the auxiliary processor 1014 (e.g., the neural processing unit) may include a hardware structure specified for artificial intelligence model processing. The artificial intelligence model may be generated via machine learning. Such learning may be performed, e.g., by the electronic device 1001 where the artificial intelligence is performed or via a separate server (e.g., the server 1007). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more of the above models but is not limited to the above examples. The artificial intelligence model may, additionally or alternatively, include a software structure other than the hardware structure.

The memory 1020 may store various data used by at least one component (e.g., the processor 1010 or the sensor module 1060) of the electronic device 1001. The various data may include, for example, software (e.g., the program 1030) and input data or output data for a command related to the software. The memory 1020 may include the volatile memory 1022 or the non-volatile memory 1024.

The program 1030 may be stored in the memory 1020 as software, and may include, for example, an operating system (OS) 1036, middleware 1034, or an application 1032.

The input module 1082 may receive a command or data to be used by other component (e.g., the processor 1010) of the electronic device 1001, from the outside (e.g., a user) of the electronic device 1001. The input module 1082 may include, for example, a microphone, a mouse, a keyboard, keys (e.g., buttons), or a digital pen (e.g., a stylus pen).

The sound module 1040 may include a sound processing module 1042 or a sound output module 1044. The sound output module 1044 may output audio signals to the outside of the electronic device 1001. The sound output module 1044 may include, e.g., a speaker. The speaker may be used for general purposes, such as playing multimedia or playing record. The sound processing module 1042 may convert a sound into an electrical signal and vice versa. According to an example, the sound module 1040 may obtain the sound via the input module 1082, or output the sound via the sound output module 1044 or a headphone of an external electronic device (e.g., the electronic device 1003) directly (e.g., through a wire or wires) or wirelessly coupled with the electronic device 1001.

The image module 1050 may include an image processing module 1052 or an image output module 1054. The image processing module 1052 may output video signals to the outside of the electronic device 1001. The image output module 1054 may include, e.g., a display and/or a light projector. The light projector may convert electrical video signals into optical signals and output them. The image processing module 1052 may convert an image into an electrical signal, or may convert an electrical signal into an image. According to an example, the image module 1050 may obtain the image through the input module 1082, or output the image through the image output module 1054 or an external electronic device (e.g., the electronic device 1003) directly or wirelessly connected with the electronic device 1001. The image module 1050 may include, for example, a display, a hologram device, or a projector and control circuitry to control a corresponding one of the display, hologram device, and projector.

The sensor module 1060 may detect an operational state (e.g., power or temperature) of the electronic device 1001 or an environmental state (e.g., a state of a user) external to the electronic device 101, and then generate an electrical signal or data value corresponding to the detected state. According to an example, the sensor module 1060 may include, e.g., a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1084 may support one or more specified protocols to be used for the electronic device 1001 to be coupled with the external electronic device (e.g., the electronic device 1003) directly (e.g., through a wire or wires) or wirelessly. The interface 1084 may include, e.g., a high definition multimedia interface (HDMI), a universal serial bus (USB) interface, a secure digital (SD) card interface, or an audio interface (e.g., Bixby).

A connecting terminal 1086 may include a connector via which the electronic device 1001 may be physically connected with the external electronic device (e.g., the electronic device 1003). According to an example, the connecting terminal 1086 may include, for example, a HDMI connector, a USB connector, a SD card connector, or an audio connector (e.g., a headphone connector).

The power management module 1070 may manage power supplied to the electronic device 1001. According to an embodiment, the power management module 1070 may be implemented as at least part of, for example, a power management integrated circuit (PMIC).

The communication module 1090 may support establishing a direct (e.g., wired) communication channel or a wireless communication channel between the electronic device 1001 and the external electronic device (e.g., the electronic device 1003, the electronic device 1005, or the server 1007) and performing communication via the established communication channel. The communication module 1090 may include one or more communication processors that are operable independently from the processor 1010 (e.g., the application processor (AP)) and supports a direct (e.g., wired) communication or a wireless communication. According to an example, the communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device 1005 via a first network 1098 (e.g., a short-range communication network, such as Bluetooth™, wireless-fidelity (Wi-Fi) direct, or infrared data association (IrDA)) or a second network 1096 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 1092 may identify or authenticate the electronic device 1001 in a communication network, such as the first network 1098 or the second network 1096, using subscriber information (e.g., international mobile subscriber identity (IMSI)).

The wireless communication module 1092 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1092 may support a high-frequency band (e.g., the mmWave band) to achieve, e.g., a high data transmission rate. The wireless communication module 1092 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1092 may support various requirements specified in the electronic device 1001, an external electronic device (e.g., the electronic device 1005), or a network system (e.g., the second network 1096). According to an embodiment, the wireless communication module 1092 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an example, commands or data may be transmitted or received between the electronic device 1001 and the external electronic device 1005 via the server 1007 coupled with the second network 1096. The external electronic devices 1003 or 1005 each may be a device of the same or a different type from the electronic device 1001. According to an example, all or some of operations to be executed at the electronic device 1001 may be executed at one or more of the external electronic devices 1003, 1005, or 1007. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1001. The electronic device 1001 may provide the outcome, with or without further processing of the outcome, as at least part of a reply to the request. To that end, a cloud computing, distributed computing, mobile edge computing (MEC), or client-server computing technology may be used, for example. The electronic device 1001 may provide ultra-low-latency services using, e.g., distributed computing or mobile edge computing. In an embodiment, the external electronic device 1005 may include an internet-of-things (IoT) device. The server 1007 may be an intelligent server using machine learning and/or a neural network. According to an example, the external electronic device 1005 or the server 1007 may be included in the second network 1096. The electronic device 1001 may be applied to intelligent services (e.g., smart home, smart city, smart car, or health-care) based on 5G communication technology or IoT-related technology.

According to an example, the image projection apparatus 100 may include at least one distance sensor (ToF) 420. The image projection apparatus 100 may include an image projector 440. The image projection apparatus 100 may include at least one memory 430 including a non-volatile storage medium storing instructions. The image projection apparatus 100 may include at least one processor 410 including a processing circuit. When the instructions, executed individually or collectively by the at least one processor 410, may cause the image projection apparatus 100 to perform at least one operation. The at least one operation may include determining operation 530 a brightness variation coefficient 531, 630, or 660 regarding an input pixel bin or bin′ to a gradation conversion model 521, 620, or 650 and an output pixel bout2 or bout2′ corresponding to the input pixel bin or bin′. The at least one operation may include obtaining operation 530 a projection plane deviation correction coefficient 535 reflecting a characteristic 525 of a projection plane 110 obtained from the at least one distance sensor 420. The at least one operation may include generating an output image 403 to be projected onto a projection region 120 of the projection plane 110 by the image projector 440 by correcting a brightness for a pixel of an input image 401 considering at least one of the brightness variation coefficient 531, 630, or 660 and the projection plane deviation correction coefficient 535.

According to an example, the gradation conversion model 620 or 650 may be preset during a manufacturing process.

According to an example, when the instructions, executed individually or collectively by the at least one processor 410, may further cause the image projection apparatus 100 to obtain (operation 530) an optical deviation correction coefficient 533 reflecting a vignetting characteristic 523 of a lens included in the image projector 440.

According to an example, when the instructions, executed individually or collectively by the at least one processor 410, may further cause the image projection apparatus 100 to determine (operation 530) a first projection plane deviation correction coefficient based on length information d1, d2, d3, d4 about projection beams to display ‘display pixels’ of the projection region 120.

According to an example, when the instructions, executed individually or collectively by the at least one processor 410, may further cause the image projection apparatus 100 to perform (operation 540) brightness correction for pixels of the input image 401 considering the first projection plane deviation correction coefficient, the brightness variation coefficient, and the optical deviation correction coefficient.

According to an example, when the instructions, executed individually or collectively by the at least one processor 410, may further cause the image projection apparatus 100 to determine (operation 530) a second projection plane deviation correction coefficient based on direction information about projection beams to display pixels of the projection region 120.

According to an example, when the instructions, executed individually or collectively by the at least one processor 410, may further cause the image projection apparatus 100 to perform (operation 540) brightness correction for pixels of the input image 401 considering the second projection plane deviation correction coefficient, the brightness variation coefficient, and the optical deviation correction coefficient.

According to an example, when the instructions, executed individually or collectively by the at least one processor 410, may further cause the image projection apparatus 100 to determine (operation 530) a second projection plane deviation correction coefficient based on an incident angle θi by a normal vector ni corresponding to a position of a target pixel Pi on the projection plane (output screen) 820 and a beam vector ri of the target pixel Pi.

According to an example, when the instructions, executed individually or collectively by the at least one processor 410, may further cause the image projection apparatus 100 to perform (operation 540) brightness correction for pixels of the input image 401 considering the second projection plane deviation correction coefficient, the brightness variation coefficient, and the optical deviation correction coefficient.

According to an example, when the instructions, executed individually or collectively by the at least one processor 410, may further cause the image projection apparatus 100 to determine (operation 530) a first projection plane deviation correction coefficient based on length information d1, d2, d3, d4 about projection beams to display pixels of the projection region 120.

According to an example, when the instructions, executed individually or collectively by the at least one processor 410, may further cause the image projection apparatus 100 to determine (operation 530) a second projection plane deviation correction coefficient based on an incident angle θi by a normal vector ni corresponding to a position of a target pixel Pi on the projection plane (output screen) 820 and a beam vector ri of the target pixel Pi.

According to an example, when the instructions, executed individually or collectively by the at least one processor 410, may further cause the image projection apparatus 100 to perform (operation 540) brightness correction for pixels of the input image 401 considering the first projection plane deviation correction coefficient, the second projection plane deviation correction coefficient, the brightness variation coefficient, and the optical deviation correction coefficient.

According to an example, when the instructions, executed individually or collectively by the at least one processor 410, may further cause the image projection apparatus 100 to obtain (operation 530) the optical deviation correction coefficient 533 corresponding to each of a plurality of partial display regions 731, 733, 735, 737 from a lookup table preset based on the vignetting characteristic.

According to an example, the plurality of partial display regions 731, 733, 735, 737 may be projection regions obtained by dividing the projection region 120 based on a change in the vignetting characteristic.

According to an example, the optical deviation correction coefficient may have a relatively larger value in a first partial display region 737 distant from a center point of the projection region 120 than in a second partial display region 731 near the center point.

According to an example, when the instructions, executed individually or collectively by the at least one processor 410, may further cause the image projection apparatus 100 to determine (operation 530) an inter-beam angle Φ1 or Φ2 between a first projection beam 751 for displaying a center pixel 741 of the projection region 120 and a second projection beam 753 or 755 for displaying a specific pixel 743 or 745.

According to an example, when the instructions, executed individually or collectively by the at least one processor 410, may further cause the image projection apparatus 100 to obtain (operation 530) the optical deviation correction coefficient corresponding to some or all target pixels included in the display pixels based on the inter-beam angle Φ1 or Φ2.

According to an example, the optical deviation correction coefficient may have a relatively larger value for a first target pixel 743 having a smaller inter-beam angle Φ2 than for a second target pixel 745 having a larger inter-beam angle Φ1.

According to an example, a method for operating an image projection apparatus 100 may include determining (operation 530) a brightness variation coefficient 531, 630, or 660 regarding an input pixel bin or bin′ to a gradation conversion model 521, 620, or 650 and an output pixel bout2 or bout2′ corresponding to the input pixel bin or bin′. The operation method may include obtaining (operation 530) a projection plane deviation correction coefficient 535 reflecting a characteristic 525 of a projection plane 110 obtained from the at least one distance sensor 420. The operation method may include generating an output image 403 to be projected onto a projection region 120 of the projection plane 110 by the image projector 440 by correcting a brightness for a pixel of an input image 401 considering at least one of the brightness variation coefficient 531, 630, or 660 and the projection plane deviation correction coefficient 535.

According to an example, the gradation conversion model 620 or 650 may be preset during a manufacturing process.

According to an example, the operation method may further include obtaining (operation 530) an optical deviation correction coefficient 533 reflecting a vignetting characteristic 523 of a lens included in the image projector 440.

According to an example, obtaining the projection plane deviation correction coefficient 535 may include determining (operation 530) a first projection plane deviation correction coefficient based on length information d1, d2, d3, d4 about projection beams to display pixels of the projection region 120.

According to an example, generating the output image 403 may include performing (operation 540) brightness correction for pixels of the input image 401 considering the first projection plane deviation correction coefficient, the brightness variation coefficient, and the optical deviation correction coefficient.

According to an example, obtaining the projection plane deviation correction coefficient 535 may include determining (operation 530) a second projection plane deviation correction coefficient based on direction information about projection beams to display pixels of the projection region 120.

According to an example, generating the output image 403 may include performing (operation 540) brightness correction for pixels of the input image (401) considering the second projection plane deviation correction coefficient, the brightness variation coefficient, and the optical deviation correction coefficient.

According to an example, obtaining the projection plane deviation correction coefficient 535 may include determining (operation 530) a second projection plane deviation correction coefficient based on an incident angle θi by a normal vector ni corresponding to a position of a target pixel Pi on the projection plane (output screen) 820 and a beam vector ri of the target pixel Pi.

According to an example, generating the output image 403 may include performing (operation 540) brightness correction for pixels of the input image 401 considering the second projection plane deviation correction coefficient, the brightness variation coefficient, and the optical deviation correction coefficient.

According to an example, obtaining the projection plane deviation correction coefficient 535 may include determining (operation 530) a first projection plane deviation correction coefficient based on length information d1, d2, d3, d4 about projection beams to display pixels of the projection region 120.

According to an example, generating the output image 403 may include determining (operation 530) a second projection plane deviation correction coefficient based on an incident angle θi by a normal vector ni corresponding to a position of a target pixel Pi on the projection plane (output screen) 820 and a beam vector ri of the target pixel Pi.

According to an example, obtaining (operation 530) the optical deviation correction coefficient 533 may include correcting (operation 540) pixels of the input image 401 considering the first projection plane deviation correction coefficient, the second projection plane deviation correction coefficient, the brightness variation coefficient, and the optical deviation correction coefficient.

According to an example, obtaining (530) the optical deviation correction coefficient 533 may include obtaining (operation 530) the optical deviation correction coefficient 533 corresponding to each of a plurality of partial display regions 731, 733, 735, 737 from a lookup table preset based on the vignetting characteristic.

According to an example, the plurality of partial display regions 731, 733, 735, 737 may be projection regions obtained by dividing the projection region 120 based on a change in the vignetting characteristic.

According to an example, the optical deviation correction coefficient may have a relatively larger value in a first partial display region 737 distant from a center point of the projection region 120 than in a second partial display region 731 near the center point.

According to an example, obtaining (operation 530) the optical deviation correction coefficient 533 may include determining (operation 530) an inter-beam angle Φ1 or Φ2 between a first projection beam 751 for displaying a center pixel 741 of the projection region 120 and a second projection beam 753 or 755 for displaying a specific pixel 743 or 745.

According to an example, obtaining (operation 530) the optical deviation correction coefficient 533 may include obtaining (operation 530) the optical deviation correction coefficient corresponding to some or all target pixels included in the display pixels based on the inter-beam angle Φ1 or Φ2.

According to an example, the optical deviation correction coefficient may have a relatively larger value for a first target pixel 743 having a smaller inter-beam angle Φ2 than for a second target pixel 745 having a larger inter-beam angle Φ1.

According to an example, when executed by at least a portion of at least one processor 410 included in an image projection apparatus 100, computer-readable instructions stored in a storage medium may cause the image projection apparatus 100 to perform at least one operation. The at least one operation may include determining operation 530 a brightness variation coefficient 630 or 660 regarding an input pixel bin or bin′ to a gradation conversion model 620 or 650 and an output pixel bout2 or bout2′ corresponding to the input pixel bin or bin′. According to an example, the at least one operation may include obtaining (operation 530) an optical deviation correction coefficient reflecting a vignetting characteristic of a lens included in the image projector 440. The at least one operation may include generating an output image 403 to be projected onto a projection region 120 of the projection plane 110 by the image projector 440 by correcting a brightness for a pixel of an input image 401 considering at least one of the brightness variation coefficient 630 or 660 and the projection plane deviation correction coefficient.

According to an example, there may be provided a storage medium storing computer-readable instructions. When executed by at least a portion of at least one processor included in the image projection apparatus 100, the instructions may cause the image projection apparatus (100) to perform at least one operation. The at least one operation may include determining operation 530 a brightness variation coefficient 531, 630, or 660 regarding an input pixel bin or bin′ to a gradation conversion model 521, 620, or 650 and an output pixel bout2 or bout2′ corresponding to the input pixel bin or bin′. The at least one operation may include obtaining operation 530 a projection plane deviation correction coefficient 535 reflecting a characteristic 525 of a projection plane 110 obtained from the at least one distance sensor 420. The at least one operation may include generating an output image 403 to be projected onto a projection region 120 of the projection plane 110 by the image projector 440 by correcting a brightness for a pixel of an input image 401 considering at least one of the brightness variation coefficient 531, 630, or 660 and the projection plane deviation correction coefficient 535.

The electronic device according to one or more embodiments may be one of various types of electronic devices. The electronic devices may include, for example, a display device (e.g., a TV, a monitor, or a light projection device), a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that one or more embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., through a wire or wires), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., the memory 430) that is readable by a machine (e.g., the image projection apparatus 100). For example, a processor (e.g., the processor 410) of the machine (e.g., the image projection apparatus 100) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An image projection apparatus comprising:
at least one distance sensor;
an image projector;
at least one memory comprising a non-volatile storage medium storing instructions; and
at least one processor operatively connected with the at least one distance sensor, the image projector, and the at least one memory and comprising a processing circuit,
wherein the instructions, when executed by the at least one processor individually or collectively, cause the image projection apparatus to:
determine a brightness variation coefficient regarding an input pixel to a gradation conversion model and an output pixel corresponding to the input pixel;
obtain a projection plane deviation correction coefficient reflecting a characteristic of a projection plane obtained from the at least one distance sensor; and
generate an output image to be projected by the image projector onto a projection region of the projection plane by correcting a brightness of a pixel of an input image based on at least one of the brightness variation coefficient or the projection plane deviation correction coefficient.

2. The image projection apparatus of claim 1, wherein the gradation conversion model is set during a manufacturing process.

3. The image projection apparatus of claim 1, wherein the instructions, when executed by the at least one processor individually or collectively, further cause the image projection apparatus to:
obtain an optical deviation correction coefficient reflecting a vignetting characteristic of a lens in the image projector;
determine a first projection plane deviation correction coefficient based on length information about projection beams to display pixels of the projection region; and
perform brightness correction for pixels of the input image, based on the first projection plane deviation correction coefficient, the brightness variation coefficient, and the optical deviation correction coefficient.

4. The image projection apparatus of claim 1, wherein the instructions, when executed by the at least one processor individually or collectively, further cause the image projection apparatus to:
obtain an optical deviation correction coefficient reflecting a vignetting characteristic of a lens in the image projector;
determine a second projection plane deviation correction coefficient, based on direction information about projection beams to display pixels of the projection region; and
perform brightness correction for pixels of the input image, based on the second projection plane deviation correction coefficient, the brightness variation coefficient, and the optical deviation correction coefficient.

5. The image projection apparatus of claim 1, wherein the instructions, when executed by the at least one processor individually or collectively, further cause the image projection apparatus to:
obtain an optical deviation correction coefficient reflecting a vignetting characteristic of a lens in the image projector;
determine a second projection plane deviation correction coefficient based on an incident angle by a normal vector corresponding to a position of a target pixel on the projection plane and a beam vector of the target pixel; and
perform brightness correction for pixels of the input image, based on the second projection plane deviation correction coefficient, the brightness variation coefficient, and the optical deviation correction coefficient.

6. The image projection apparatus of claim 1, wherein the instructions, when executed by the at least one processor individually or collectively, further cause the image projection apparatus to:
obtain an optical deviation correction coefficient reflecting a vignetting characteristic of a lens in the image projector;
determine a first projection plane deviation correction coefficient based on length information about projection beams to display pixels of the projection region;
determine a second projection plane deviation correction coefficient based on an incident angle by a normal vector corresponding to a position of a target pixel on the projection plane and a beam vector of the target pixel; and
perform brightness correction for pixels of the input image, based on the first projection plane deviation correction coefficient, the second projection plane deviation correction coefficient, the brightness variation coefficient, and the optical deviation correction coefficient.

7. The image projection apparatus of claim 3, wherein the instructions, when executed by the at least one processor individually or collectively, further cause the image projection apparatus to obtain the optical deviation correction coefficient corresponding to each of a plurality of partial display regions from a lookup table set based on the vignetting characteristic, and
wherein the plurality of partial display regions are projection regions obtained by dividing the projection region based on a change in the vignetting characteristic.

8. The image projection apparatus of claim 7, wherein the optical deviation correction coefficient has a relatively larger value in a first partial display region distant from a center point of the projection region than in a second partial display region near the center point.

9. The image projection apparatus of claim 3, wherein the instructions, when executed by the at least one processor individually or collectively, further cause the image projection apparatus to:
determine an inter-beam angle between a first projection beam for displaying a center pixel of the projection region and a second projection beam for displaying a specific pixel; and
obtain the optical deviation correction coefficient corresponding to at least one target pixel in the display pixels based on the inter-beam angle.

10. The image projection apparatus of claim 9, wherein the optical deviation correction coefficient has a relatively larger value for a first target pixel having a smaller inter-beam angle than for a second target pixel having a larger inter-beam angle.

11. A method for operating an image projector, the method comprising:
determining a brightness variation coefficient regarding an input pixel to a gradation conversion model and an output pixel corresponding to the input pixel;
obtaining a projection plane deviation correction coefficient reflecting a characteristic of a projection plane obtained from an at least one distance sensor; and
generating an output image to be projected by the image projector onto a projection region of the projection plane by correcting a brightness of a pixel of an input image, based on at least one of the brightness variation coefficient or the projection plane deviation correction coefficient.

12. The method of claim 11, wherein the gradation conversion model is set during a manufacturing process.

13. The method of claim 11, further comprising obtaining an optical deviation correction coefficient reflecting a vignetting characteristic of a lens in the image projector,
wherein the obtaining the projection plane deviation correction coefficient comprises determining a first projection plane deviation correction coefficient based on length information about projection beams to display pixels of the projection region, and
wherein the generating the output image comprises performing brightness correction for pixels of the input image, based on the first projection plane deviation correction coefficient, the brightness variation coefficient, and the optical deviation correction coefficient.

14. The method of claim 11, further comprising obtaining an optical deviation correction coefficient reflecting a vignetting characteristic of a lens in the image projector,
wherein the obtaining the projection plane deviation correction coefficient comprises determining a second projection plane deviation correction coefficient based on direction information about projection beams to display pixels of the projection region, and
wherein the generating the output image comprises performing brightness correction for pixels of the input image, based on the second projection plane deviation correction coefficient, the brightness variation coefficient, and the optical deviation correction coefficient.

15. The method of claim 11, further comprising obtaining an optical deviation correction coefficient reflecting a vignetting characteristic of a lens in the image projector,
wherein the obtaining the projection plane deviation correction coefficient comprises determining a second projection plane deviation correction coefficient based on an incident angle by a normal vector corresponding to a position of a target pixel on the projection plane and a beam vector of the target pixel, and
wherein the generating the output image comprises performing brightness correction for pixels of the input image, based on the second projection plane deviation correction coefficient, the brightness variation coefficient, and the optical deviation correction coefficient.

16. The method of claim 11, further comprising obtaining an optical deviation correction coefficient reflecting a vignetting characteristic of a lens in the image projector,
wherein the obtaining the projection plane deviation correction coefficient comprises:
determining a first projection plane deviation correction coefficient based on length information about projection beams to display pixels of the projection region and
determining a second projection plane deviation correction coefficient based on an incident angle by a normal vector corresponding to a position of a target pixel on the projection plane and a beam vector of the target pixel, and
wherein the generating the output image comprises performing brightness correction for pixels of the input image based on the first projection plane deviation correction coefficient, the second projection plane deviation correction coefficient, the brightness variation coefficient, and the optical deviation correction coefficient.

17. The method of claim 13, wherein the obtaining the optical deviation correction coefficient comprises obtaining the optical deviation correction coefficient corresponding to each of a plurality of partial display regions from a lookup table set based on the vignetting characteristic, and
wherein the plurality of partial display regions are obtained by dividing the projection region, based on a change in the vignetting characteristic.

18. The method of claim 17, wherein the optical deviation correction coefficient has a relatively larger value in a first partial display region distant from a center point of the projection region than in a second partial display region near the center point.

19. The method of claim 13, wherein the obtaining the optical deviation correction coefficient, comprises:
determining an inter-beam angle between a first projection beam for displaying a center pixel of the projection region and a second projection beam for displaying a specific pixel; and
obtaining the optical deviation correction coefficient corresponding to at least one target pixel in the display pixels based on the inter-beam angle.

20. The method of claim 19, wherein the optical deviation correction coefficient has a relatively larger value for a first target pixel having a smaller inter-beam angle than for a second target pixel having a larger inter-beam angle.
